(19) United States
(12) Patent Application Publication
(10) Pub. No.: US 2015/0034539 A1
(43) Pub. Date: Feb. 5, 2015

(54) ALGAE SCRUBBER MACROALGAL ATTACHMENT MATERIALS - APPENDAGES

(71) Applicant: Bryan H. Farrish, Santa Monica, CA (US)

(72) Inventor: Bryan H. Farrish, Santa Monica, CA (US)

(21) Appl. No.: 14/380,926

(22) PCT Filed: Mar. 8, 2013
(86) PCT No.: PCT/US2013/030019

§ 371 Date: Aug. 25, 2014

Related U.S. Application Data
(60) Provisional application No. 61/644,376, filed on May 8, 2012.
(60) Provisional application No. 61/649,921, filed on May 21, 2012.
(60) Provisional application No. 61/663,602, filed on Jun. 24, 2012.
(60) Provisional application No. 61/671,024, filed on Jul. 12, 2012.
(60) Provisional application No. 61/675,305, filed on Jul. 24, 2012.
(60) Provisional application No. 61/679,643, filed on Aug. 3, 2012.
(60) Provisional application No. 61/703,726, filed on Sep. 20, 2012.
(60) Provisional application No. 61/739,703, filed on Dec. 19, 2012.

(51) Int. Cl. C02F 3/32; A01G 33/00; C02F 3/10

(52) U.S. Cl. CPC C02F 3/322; C02F 3/109; A01G 33/00; C02F 2203/006; C02F 2101/105
USPC 210/150

(57) ABSTRACT

An apparatus for macroalgal attachment in an algae scrubber or seaweed cultivator comprising a set of discrete non-connected appendages extending from a support member such that the appendages receive water flow and illumination so as to cause macroalgae to attach to and grow on said appendages, whereby said macroalgal growth can be comb harvested to provide useful biomass or to remove nutrients from the water. Attachment textures and growth compartments are also claimed.

### CROSS-REFERENCE TO RELATED APPLICATIONS

This application claims the benefit of U.S. Provisional Application No. 61/609,280, filed Mar. 10, 2012, U.S. Provisional Application No. 61/644,376, filed May 8, 2012, U.S. Provisional Application No. 61/649,921, filed May 21, 2012, U.S. Provisional Application No. 61/663,602, filed Jun. 24, 2012, U.S. Provisional Application No. 61/671,024, filed Jul. 12, 2012, U.S. Provisional Application No. 61/675,305, filed Jul. 24, 2012, U.S. Provisional Application No. 61/679,643, filed Aug. 3, 2012, U.S. Provisional Application No. 61/703,726, filed Sep. 20, 2012, and U.S. Provisional Application No. 61/739,703, filed Dec. 19, 2012.

### FIELD

An embodiment of the invention generally relates to macroalgal attachment appendages for algae scrubbers that filter water or nutrients by using illumination to grow macroalgae on the appendages. Other embodiments are also described.

### BACKGROUND

Many industries rely on “clean” water for proper operation. In the current application, “clean” is defined to mean water that is low in nutrients, specifically: Inorganic Nitrate, Inorganic Phosphate, Nitrite, Ammonia, Ammonium, and metals such as Copper. These nutrients cause problems such as excessive algae and bacterial growth, and in some cases, poisoning of livestock. In these instances, algae disperse in the water in an uncontrolled manner, thereby making algae removal difficult. Thus there is a desire to remove nutrients and associated algae so as to maintain clean water. “Scrubbing” is defined to mean the removal of these nutrients using attached macroalgal growth which is periodically harvested. Furthermore, some scrubbing techniques utilize upflowing gas bubbles to enable the macroalgae to grow on an attachment surface, and are thus termed “upflow algae scrubbers”, whereas other scrubbing techniques utilize falling water for the same and are thus termed “waterfall algae scrubbers”. Excessively thick algal growth on prior art planar macroalgal attachment surfaces, however, can block sufficient light and water from reaching the “roots” of the algal growth that are attached to the surface, and this will reduce filtering capacity because the dying roots will detach and float away, preventing their harvesting. In addition, scrubbing techniques which use only a planar attachment surface create harvesting difficulty because the entire surface may need to be removed in order to harvest it.

FIG. 1A illustrates one such prior art scrubber having a planar attachment surface. Representatively, the scrubber 100 includes attachment surface 104 and a support member 102. It can be seen from FIG. 1A that it is difficult to harvest from planar attachment surface 104 because as the user's hand 108 tries to push algal growth down and off of the attachment surface 104 in direction 110 with scraper 106 down the planar attachment surface 104 in direction 110, the attachment surface 104 moves away from the user's hand 108. Users many times have to get under aquariums, or hold cabinet doors open with one hand, and thus it may be considerably more difficult to harvest when two hands are needed. This is a primary reason that prior art attachment surfaces are usually removed from operation before harvesting.

Moreover, as can be seen from FIG. 1B, algal growth on prior art planar attachment surfaces is not optimal. In particular, the bands surrounding planar attachment surface 104 represent a cross-section of algal growth on the surface, and the arrows 110, 112, 114, 116 and 118 represent the penetration of illumination into that growth. The “macroalgal growth” legend shows levels of darkness of the bands 130, 132 and 134 which represent the growth state of the algae: furthest from the attachment surface 104 is new growth 134 that has not been grown-over yet; as you move in further towards the attachment surface 104, however, the legend represents darker growth 132 which has been shaded by the newer outer growth. This darker growth does not produce algal biomass or filtering very fast, if at all, due to the shading and blocked water flow. Lastly, the innermost growth band 130 shows the darkest growth, and is representative of near-dead or dead algae due to almost completely blocked illumination and water flow by the outer layers. Unfortunately, it is this innermost section of algae that are the “roots” of all the rest of the algae, and thus this innermost section must maintain a secure hold on the attachment surface 104 while the outer algal layers are trying to pull away due to the rapidly flowing water and/or gas bubble activity on the outer layers.

As can be seen from FIG. 1B, however, attachment surface 104 suffers from light blockage in its middle portion because this section does not benefit from side-illumination. Thus, many times while lifting attachment surface 104 out of the water, the growth will fall off of a section in the center which is usually the section with the thickest growth (and which blocked the most illumination). The section of the attachment surface 104 where the algae falls off will show a light-brown wheat looking growth, which is actually dead algae. Dead algae has no strength and thus lets go of the green growth on top of it. Thus, planar attachment surfaces such as attachment surface 104 have approximately a 1:1 ratio of illumination area to root-attachment area, which is the lowest possible.

FIG. 1C illustrates a top-down view into scrubber 100. In this view, the planar attachment surface is hidden by the algal growth. The image shows only one side of the surface (the left side), and the illumination source 120, which is further to the left of this. As can be seen from this view, a 20 mm distance inside the growth compartment, nearest to the illumination source 120, the growth is healthy 124; to the right of this 20 mm distance (which is farthest from the illumination source), black areas 126 of growth can be seen. This dark or black area 126 nearest to the planar attachment surface on the right is due to the growth being thicker than 20 mm. In this aspect, when the planar attachment surface 104 is lifted out of a growth compartment, algae falls off of the planar attachment surface 104. In addition, the part of the algal growth that attaches to the planar attachment surface 104 is farthest from the source of illumination 120, and buried under the most growth, and thus dies and detaches from the planar attachment surface 104.

Lastly, the opaque compartment surfaces, which normally hold macroalgal growth until harvesting normally provide no filtering function, and can actually reduce filtering by allowing growth to begin but then letting the growth detach.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1A illustrates a prior art scrubber having a planar attachment surface.

FIG. 1B shows a cross-section of algal growth on a prior art planar attachment surface.

FIG. 1C illustrates a top-down view into scrubber 100.

FIG. 2 illustrates a perspective view of one embodiment of an appendage that can be used in a scrubber or seaweed cultivator.

FIG. 3 illustrates a perspective view of another embodiment of an appendage for use in a scrubber or seaweed cultivator.

FIG. 4A shows a cross-sectional shape of one embodiment of an appendage for use in a scrubber or seaweed cultivator.

FIG. 4B shows a cross-sectional shape of one embodiment of an appendage for use in a scrubber or seaweed cultivator.

FIG. 4C shows a cross-sectional shape of one embodiment of an appendage for use in a scrubber or seaweed cultivator.

FIG. 4D shows a cross-sectional shape of one embodiment of an appendage for use in a scrubber or seaweed cultivator.

FIG. 4E shows a cross-sectional shape of one embodiment of an appendage for use in a scrubber or seaweed cultivator.

FIG. 4F shows a cross-sectional shape of one embodiment of an appendage for use in a scrubber or seaweed cultivator.

FIG. 4G shows a cross-sectional shape of one embodiment of an appendage for use in a scrubber or seaweed cultivator.

FIG. 4H shows a cross-sectional shape of one embodiment of an appendage for use in a scrubber or seaweed cultivator.

FIG. 4I shows a cross-sectional shape of one embodiment of an appendage for use in a scrubber or seaweed cultivator.

FIG. 5 is a graph illustrating the effect of self-shading of the “chaetomorpha” genus of green algae.

FIG. 6 shows a cross section of an appendage for a scrubber or seaweed cultivator in water.

FIG. 7 shows a top plan view of one embodiment of an attachment appendage for a scrubber or algal cultivator surrounded by a thickness “T” of algal growth.

FIG. 8A shows a graph illustrating one exemplary Illumination Ratio.

FIG. 8B shows a graph illustrating another exemplary Illumination Ratio.

FIG. 9A illustrates an embodiment of an appendage for use in a scrubber or seaweed cultivator.

FIG. 9B illustrates an embodiment of an appendage for use in a scrubber or seaweed cultivator.

FIG. 9C illustrates an embodiment of an appendage for use in a scrubber or seaweed cultivator.

FIG. 9D illustrates an embodiment of an appendage for use in a scrubber or seaweed cultivator.

FIG. 9E illustrates an embodiment of an appendage for use in a scrubber or seaweed cultivator.

FIG. 10 shows a perspective view of one embodiment of a linear waterfall algae scrubber over a container of water.

FIG. 11 shows a perspective view of another embodiment of an algae scrubber.

FIG. 12 shows a perspective view of one embodiment of a linear waterfall scrubber such as that of FIG. 10 or FIG. 11, with macroalgal growth and a harvesting comb.

FIG. 13 shows a perspective view of another embodiment of a waterfall scrubber.

FIG. 14 shows a perspective view of a linear upflow string appendage embodiment of the present invention.

FIG. 15 shows a perspective view of the linear upflow string appendage embodiment of FIG. 14, with macroalgal growth and a harvesting comb.

FIG. 16 shows a perspective view of another embodiment of a scrubber.

FIG. 17 shows a perspective view of another embodiment of a scrubber.

FIG. 18 shows a perspective view of one embodiment of an upflow scrubber.

FIG. 19 illustrates a perspective view of an embodiment of a non-linear upflow algae scrubber.

FIG. 20 shows the non-linear upflow algae scrubber of FIG. 19 having attached macroalgal growth and a harvesting comb.

FIG. 21 illustrates an embodiment of a non-linear upflow scrubber.

FIG. 22 illustrates a perspective view of another embodiment of a scrubber.

FIG. 23 illustrates a perspective view of one embodiment of a scrubber.

FIG. 24 illustrates a perspective view of one embodiment of an illumination port as defined in the present application, and in the growth compartment of FIG. 23.

FIG. 25 illustrates a perspective view of one embodiment of a section of a growth compartment with planar surfaces as the attachment surfaces.

FIG. 26 illustrates a magnified perspective view of a section of an inner texture appendage surface of a growth compartment.

FIG. 27 illustrates an exploded perspective view of one embodiment of a scrubber which utilizes different types of appendages.

FIG. 28 illustrates a perspective view of the top of a tubular algae scrubber housing with a macroalgal attachment planar surface inside.

FIG. 29 illustrates a perspective view of one embodiment of a scrubber or seaweed cultivator.

FIG. 30 illustrates a side view of one embodiment of an upflow scrubber with reduced cross section of flow area.

FIG. 31 illustrates a perspective view of one embodiment of an upflow scrubber.

FIG. 32 illustrates a perspective view of one embodiment of a waterfall algae scrubber.

FIG. 33 illustrates a perspective view of one embodiment of a sloped waterfall scrubber.

FIG. 34 illustrates a perspective view of an embodiment of an upflow scrubber.

### DETAILED DESCRIPTION

Several embodiments of the invention with reference to the appended drawings are now explained. Whenever the shapes, relative positions and other aspects of the parts described in the embodiments are not clearly defined, the scope of the invention is not limited only to the parts shown, which are meant merely for the purpose of illustration. Also, while numerous details are set forth, it is understood that some embodiments of the invention may be practiced without these details. In other instances, well-known circuits, structures, and techniques have not been shown in detail so as not to obscure the understanding of this description.

In the process of using algal growth to filter water, the challenge has been how to grow algae easily so the algae can be removed or harvested, which thus removes nutrients from the water. If the algae are not removed, they will simply grow too thick and the underlying attaching “root” layers will die and detach as previously discussed, which will put the nutrients back into the water. Ironically, the thicker the growth, the faster the roots die due to the blocking of illumination and water flow from reaching the roots. “Harvesting” is defined herein to include the consumption of the algal growth by livestock such as snails, fish, etc., in addition to the manual removal of the algae by the user.

Algae fall into two main categories: unicellular and multi-cellular. Uni-cellular algae are microscopic organisms which drift freely in the water (e.g., plankton) and give the water a usually green tint. Thus, uni-cellular algae are usually called “micro” algae or “phyto” plankton. Multi-cellular algae are seaweeds that usually attach themselves to a surface. Since multi-cellular seaweeds are much larger than microalgae, they are usually called “macro” algae. It is these multi-cellular attached macroalgae seaweeds, which attach themselves to solid surfaces, that are the focus of several of the embodiments described herein. Micro algae, in fact, have a very hard time surviving and staying attached in the present embodiments, due to the rapid gas bubble flow and/or water flow and/or components rubbing together, but especially due to being overgrown by thick layers of the macro algae.

Many prior art waterfall algae scrubbers, using prior art planar attachment surfaces such as that previously discussed, have been designed and built. Upflow algae scrubbers (the opposite of waterfalls) are now becoming more popular, too; if gas bubbles are allowed to flow up rapidly in an “airlift” fashion along a surface, the bubbles will promote the growth of solidly attached macroalgae that will rapidly consume virtually all pertinent nutrients from the water. Moreover, rapid bubble flow and large bubble size do not impinge on macroalgal growth in the filter. Namely, the larger and more rapid the gas bubble flow, the more the algal strands are moved about, thus allowing more water and illumination to penetrate into the “roots” within the strands. Also, the large gas bubbles deliver a “wet, dry, wet, dry” action to the algae due to the insides of the gas bubbles being dry; this dry gas delivers more CO2 to the algae for better growth. Nutrients are absorbed metabolically into the cells of the algae, and the pH of the surrounding water (especially if livestock are present) generally stays below 9.0. If needed, the bubbles from an upflow algae scrubber can be eliminated with the assistance of bubble-remover attachments after the bubbles have traversed the attachment material.

As a practical example of filtering capacity, it has been shown by many aquarium hobbyists that a prior-art planar macroalgal attachment surface that is 7.5 cm wide, 10 cm tall, and which has 6 watts of fluorescent illumination on each side will be able to filter an aquarium that is fed one typical frozen cube (typically 1 cc) of fish food per day. If this feeding were doubled to two cubes per day (2 cc), the planar area of the attachment surface, and the illumination wattage, will need to be doubled to provide the same filtering and water quality. Thus, it is known how much attached algal growth needs to occur, and over how large of an attachment area, in order to provide a certain amount of filtering or biomass production.

Another practical use for algal growth is for consumer use. “Seaweed”, “sea vegetable” and “sea lettuce” are the preferred names when consumers use algae (seaweed is the only vegetable from the ocean). Skin-care wraps and baths, natural medicines, gardening fertilizers, beer/wine fermentations, and foods such as nori, dulse, and salads are all uses in which consumers require seaweed, preferable freshly grown. These home uses of seaweed (macroalgae) have increased greatly in recent years; however, there has never been a feasible way for consumers to grow their own seaweed because of the large volumes of saltwater required, along with need for water flow and strong lighting. Upflow algae scrubber embodiments, when applied to the cultivation of macroalgae in this manner (called a seaweed cultivator), solve these problems by providing a large saltwater reservoir, very strong illumination at a very close distance, and very strong agitation/flow/CO2 delivery via the upflowing gas bubbles. Also of benefit to home users is the up-growing feature of an upflow algae scrubber, which delivers the seaweed to the top of the device, within easy reach of the user. After harvesting the seaweed, the user can leave the saltwater in the device and replenish the fertilizer (nutrients) before the next growth cycle. The present invention makes this harvesting procedure easier because the seaweed can be removed from the top of the cultivator without having to remove the macroalgal attachment materials; the user simply reaches into the top of the cultivator and removes the best looking seaweed as if vegetables were being picked from a garden.

At first it was not thought that rods, ropes, ribbons or strings (hereinafter termed “appendages”) of attachment material would grow macroalgae better than the prior art planar attachment “sheets” or “screens”, because separate appendages would move around and rub each other and thus might dislodge the macroalgae that was attempting to grow on them. However, it was surprisingly and unexpectedly found that this possibility was overshadowed by the ability of illumination and water to reach the “sides” of the roots of the algae, as well as the “front and back” of the roots, because the narrow appendages (compared to wide planar surfaces) allowed illumination to reach the roots from all sides instead of just two sides; thus, the roots stayed alive longer. And the narrower the appendage, the more this is true. Further, it was originally thought that a three dimensional placement of rods, ropes, ribbons or strings would cause shading of one by another (the way trees in a forest will block a car's headlights) compared to linear placement (like fence posts). However, the ability to place illumination sources on all sides of the appendages (instead of just two sides of a planar surface), including in-between the appendages, and especially on top of the appendages (like an airplane shining a light down into a forest), solves this. Thus the rods, ropes, ribbons or strings surprisingly benefited the algal growth instead of hindering it. And the benefit of appendages compared to planar surfaces continues when it is time to harvest: the appendages can be harvested with a single hand or “comb”, in one non-stop motion, without removing the appendages from their operating location.

The concept of using appendages instead of planar surfaces was discovered when experimenting with upflow algae scrubber planar surfaces. Some planar screens were being cut into sections in order to determine how to best route gas bubble flow along them. After a few days, not only did the cut-sections maintain their growth, but they added additional growth to the sides of their cuts, thus enabling the cut-sections to have growth on all sides of the material instead of just the front and back. The sections grew more instead of less. And after more testing in other configurations, another feature was found: even though there was more growth, the appendages still did not trap debris that was flowing by (flowing down in a waterfall, flowing up in an upflow, or flowing horizontal in a sloped “river”) because the appendages were oriented lengthwise “with” the flow as opposed to perpendicular (“crosswise”) to the flow. Flowing debris could be loose algae, or even livestock; in any case, you would not want the debris to get stuck on an appendage because this would block all illumination.

Comb-harvesting is defined herein as inserting a comb-looking apparatus around and between discrete macroalgal attachment appendages, starting at the appendages' anchor points, and moving the comb along the length of the appendages in one motion from the anchor points to the loose ends of the appendages so as to remove a substantial amount of the attached algae which is then recoverable from the comb. Thus, in some embodiments, the discrete appendages are not connected together at any point so that the comb does not have to be worked in-and-around the connections, thus defeating the one-motion ease of harvesting and probably loosing algae in the process.

The macroalgal attachment appendages, whether formed into rods, ropes, ribbons or strings, may be made of any non-corrosive durable material which does not break during growth and harvesting, allows sufficient algal growth to attach, and which allows harvesting when the user pushes the growth upwards on upflow embodiments (or downwards on waterfall embodiments) with a comb apparatus, hands or fingers. Example materials might include polypropylene, polyethylene, nylon, fiberglass, polyester, or carbon fiber, or any combination thereof, and the materials might be woven, braided, monofilament, or multi-filament. Woven, braided, and rough materials make especially good attachment materials because of the extra surfaces that are available for the macroalgae to attach to. For example, one upflow algae scrubber embodiment disclosed herein employs roughed-up polypropylene rope because the material floats upwards, and the rough broken filaments and loose braids that are common to this material allow good attachment locations for macroalgae. An appendage could also be coated with a texture to add additional roughness to it, thus enhancing its attachment abilities, and further, this texture coating can contain additives (such as iron) which provide for better biological growth. The additives would slowly dissolve over a period of months or years, enabling stronger/thicker macroalgal growth until the additive was depleted.

The color of the appendage material could be translucent or transparent, which would transmit the most illumination through the material so as to reach the algae on the other side of the appendage, or it could be white or reflective, which would reflect the most illumination away from the material so as to re-illuminate the algae on the same side of the appendage. Transmission or reflection by the attachment material is desired, as opposed to absorption, so as to maximize the amount of illumination that reaches the “roots” of the macroalgae that form the attachments.

The orientation of the appendages is generally approximately perpendicular to the surface to which they are mounted, unless the surface has a horizontal (“river”) flow. For example, one embodiment which makes use of a vertical appendage orientation is an upflow algae scrubber with appendages anchored to the bottom of the scrubber, and with illumination (such as the sun) provided only from above the water surface. This embodiment allows illumination to reach all sides of the appendages as they move about in the uprising gas bubbles.

The distance between individual appendages is determined by the application, length, diameter and material of the appendages, as well as whether the embodiment is a waterfall or upflow. A primary criteria that governs a design is the thickness that macroalgae can grow before illumination can no longer reach the “roots” of the algae that attach to the appendages due to self-shading. Once the root of a single algal strand is no longer illuminated, it will die within a few days and will not only put nutrients back into the water but will also dislodge the entire remainder of the strand and let it float away. This strand may then no longer be available for harvesting. The more days that the algal strands can remain attached, the more they will grow and filter. Thus, the more efficient an appendage is at delivering illumination through the macroalgae to the roots, the larger the distance between appendages can be so as to make room for the additional growth. Likewise, the less efficient an appendage is at delivering illumination through the macroalgae to the roots, the less the distance between appendages should be so as to prevent the growth from getting thick enough to prevent what little illumination there is from reaching the roots.

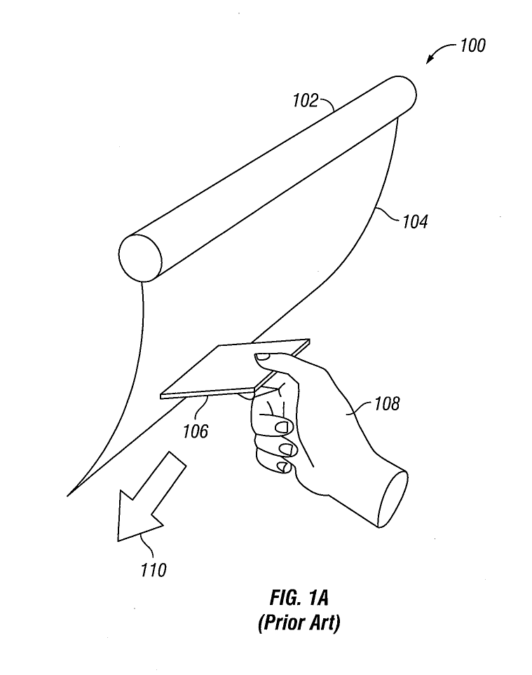

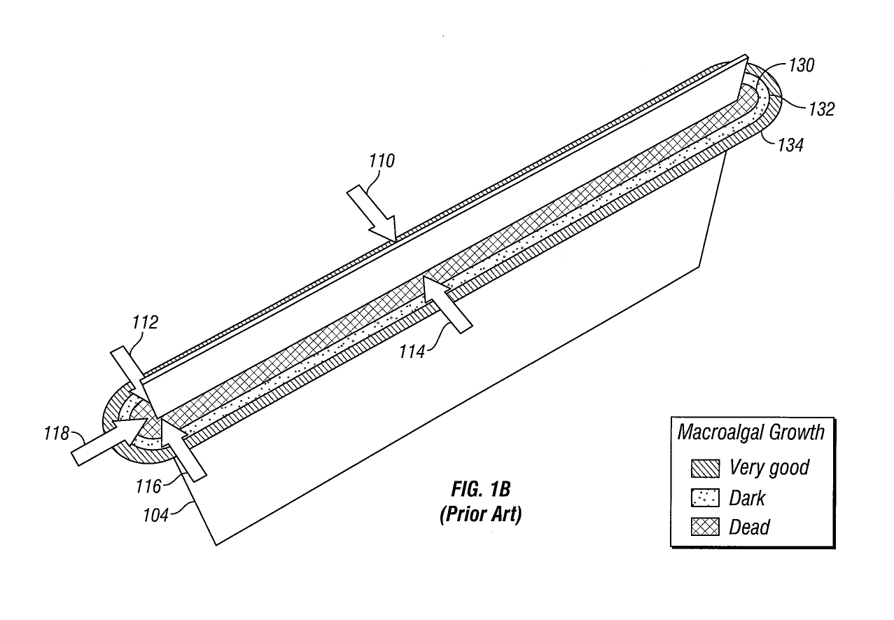

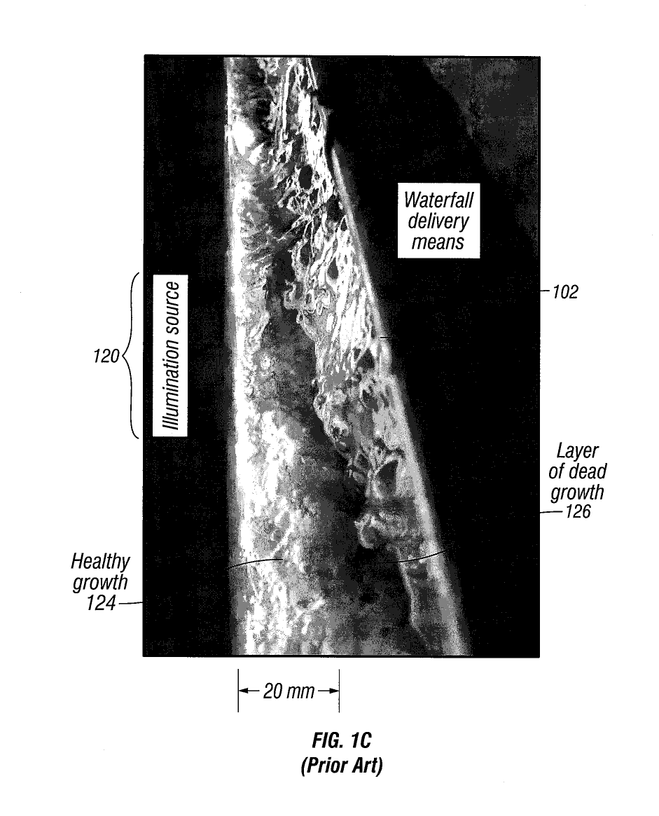

Prior art planar macroalgal attachment surfaces, such as that discussed in reference to FIG. 1A, are very inefficient at delivering illumination to the roots because a planar surface only delivers illumination from two directions: front and back. By contrast, a thin cylindrical material such as a string is the most efficient at delivering illumination to the roots because it delivers illumination equally from all directions around the string. A ribbon, defined herein as a long material with a width greater than its thickness, delivers illumination with an efficiency somewhere between a planar and cylindrical surface; the narrower the width of the ribbon (e.g., the more it resembles a string), the more efficient it is.

A major difference between prior art seaweed cultivation and the present macroalgae cultivation is the size of the growth. Most ocean cultivation focuses on large species such as Laminaria (kelp), which grow in large open patterns which allow illumination to travel between them. Green hair algae, by contrast, such as derbesia, enteromorpha (ulva), chaetomorpha, or cladophora are much more compact, allowing illumination to travel only about 20 mm through the growth before most of the illumination is blocked. While green hair algae growth in the wild will often exceed this thickness, it is often not matted down like it is in a waterfall algae scrubber embodiment, or even in an upflow embodiment. Also, algae scrubbers generate very turbulent water flow which detaches the growth sooner because of the turbulent pulling on the algal strands. Thus 20 mm is the starting point in saltwater for a working distance around each individual attachment appendage. If each appendage is expected to grow up to 20 mm thick as measured from the surface of the appendage to the edge of the growth, adjacent appendages would need to be 40 mm apart (as measured from appendage surface to appendage surface, not center to center) to allow for 20 mm of growth thickness on each appendage. Freshwater macroalgae, however, such as spirogyra, compsopogan, and stigeoclonium, usually compress into more compact layers than saltwater macroalgae do, especially in waterfall embodiments, and therefore do not need as large of a distance between attachment surfaces. In some cases, a 40 mm distance between appendage surfaces might also be applicable to saltwater upflow embodiments when the appendages are 100 to 200 mm long, or in waterfall embodiments when the appendages are 200 to 600 mm long. These lengths will not tangle too much; longer lengths may however tangle, especially when the growth is thick or solid and harvesting is attempted. Shorter lengths than these do not make good use of the vertical space available. Rigid rods, of course, could be much longer without any concerns of entanglement.

Embodiments with smaller appendages (diameter and length), and less distance between the appendage surfaces, are more suitable to regular sized aquariums and home seaweed-cultivation units because of the smaller spaces available in these applications. Also, the smaller sizes and generally indoor use of these embodiments means they could be harvested more often, thus not requiring as large of a growth distance between appendage surfaces. For example, one embodiment uses appendage diameters of 2 to 3 mm, and a distance between appendage surfaces of about 20 mm, to provide a good combination of attachment surface area and growth space. The 20 mm distance between appendage surfaces also means that the growth on each appendage can reach 10 mm before it touches the growth on the adjacent appendage; this reduced growth thickness enables greater illumination and water flow penetration through the growth because there is less growth to penetrate before reaching the attachment surfaces.

Smaller diameter appendages will generally require the appendages to be a shorter length, so as to reduce tangling. For example, upflow embodiments with appendage diameters of 2 to 3 mm, and spacing between appendage surfaces of about 20 mm, would operate best with appendage lengths of 30 to 80 mm; waterfall embodiments utilizing the same diameter and spacing would operate best with appendage lengths of 80 to 200 mm because gravity helps to prevent tangling and the appendage can be longer so as to have more surface area for growth. Some embodiments of the present invention are more resistant to tangling than others. Rigid rods, as defined herein, are generally unmovable and unbendable and therefore cannot be tangled at all. Although in reality all material will flex a certain amount, especially if formed into thin rods, if the loose ends of the rods cannot wrap around each other even when normal operational or harvesting pressure is applied, then they will be considered “rigid”.

Another very tangle-resistant embodiment of the appendage is resilient rods. Resilient rods are made of material which, when deformed via external pressure such as pushing on them with your fingers, will return back to its original position and shape when the pressure is removed. Bristles of a hair brush are an example of resilient appendages. Rigid and resilient rods, in addition to their resistance to tangling, both work well in wide, shallow upflow embodiments which do not give the gas bubbles much time to “pull” flexible appendages upwards. Thus, the stiffness of the rigid or resilient rods provides the vertical positioning instead. Rigid or resilient rods also lend themselves to more closely-spaced appendage embodiments. For example, one embodiment that uses rigid rods is constructed of rigid 3 mm translucent plastic rods that are coated with 1 mm silica quartz crystals to provide a rough jagged attachment texture for the macroalgae. The quartz crystals are glued in place with a flexible epoxy, and harvesting is done by a comb apparatus which is coated with rubber so as to not damage or dislodge the crystals.

Ribbons are a special case of appendage, because they are not cylindrical and thus have a width which must be considered; the narrower the width of the ribbon (e.g., the more it resembles a “string”), the more physical space around the ribbon is available for illumination to penetrate the macroalgae. Ribbons have a greater resistance to tangling than do strings, and thus a tradeoff can be developed between illumination efficiency and resistance to tangling. The illumination efficiency is a function of an appendage's width, thickness, and amount of algal growth expected, and is presented below as the “illumination ratio”. Ribbons are between planar surfaces and cylindrical appendages when it comes to illumination ratios; the narrower the width of the ribbon, the more growth area around the ribbon that the algae have in relation to the area of the ribbon itself. Since the material that makes up a ribbon is generally not completely transparent, it will block some illumination and thus it is also in the interest of efficiency that the size of the ribbon be minimized so as to maximize the space available for illumination to penetrate between the ribbons. Also, having a narrow appendage surface area, in general, gives the algal strands the ability to “fan out”, much like tree branches which fan out from a narrow trunk. This fanning out of the algal strands allows more illumination and water flow to penetrate the strands to reach the all-important roots which hold everything in place; the narrower the appendage diameter, the more fanning will occur. These are several of the reasons why wider appendages are not necessarily better.

While attachment materials that are manufactured specifically for the purposes described herein are certainly possible, it may be advantageous to utilize already-manufactured materials. Such materials might include synthetic rope, synthetic packaging ribbon, roughed up clothes line, synthetic carpet filaments, synthetic yarn, roughed up fishing line or tennis racquet string.

The anchoring of the appendages can be made to any stationary surface or material, since the macroalgal functionality of the appendages comes from flow along the length of the appendage (gas bubble flow too, if an upflow embodiment) instead of how the appendage is anchored. The anchoring needs to provide sufficient holding so that the appendage does not detach during normal water flow, or during harvesting. Thus, any anchoring mechanism which provides sufficient attachment, and also enables comb-harvesting, will suffice. Examples of such anchoring might be glue, friction fit, welding, ceramic tacks, passing the appendage through a hole and tying a knot on the other side, draping the appendage over or under an object, or any combination thereof. Examples of anchoring a rope in a natural body of water could be molded-in weights, or burial in a substrate. When measuring the distance between appendage surfaces, it is done at the point of anchor.

The illumination that drives the macroalgal growth may be supplied by natural or artificial means, or a combination thereof. Natural lighting would include direct sunlight, or redirected sunlight via mirrors, metal conduits or fiber optics, whereas artificial lighting would include all manner of electric bulbs, plasma displays, metal halides, light emitting diodes, other light-emitting devices, or any combination thereof. Using either artificial light or redirected natural light, the illumination source could be directly coupled to the algae scrubber unit or could be part of a separate device. In some embodiments, reflectors are provided to surround the appendages so as to increase the illumination and promote algal growth. The reflectors can be made of, or coated with, reflective materials which reflect or redirect light from the light source toward the algae growing on the attachment materials. Illumination reflectors might be made of glass mirror, plastic mirror, acrylic mirror, polished metal or aluminum or chrome, metalized paint or metal deposition, or a white paint, coating or dipping, or combinations thereof. For economy of manufacture, the illumination reflector and the algae scrubber unit might all be made of one continuous homogeneous material.

The algal illumination source, especially for aquariums, may be made of 3-watt LEDs (light emitting diodes) of the 660 nanometer (red) spectrum, and these LEDs have a heat-sink base designed to be mounted on a heat-conductive surface, and thus can be mounted using heat-conductive adhesive or with heat-conductive grease and attachment hardware. Other sources of illumination could be utilized such as compact fluorescent (CFL) bulbs, whereas other embodiments might have several 1-watt LEDs or other illumination sources arranged in a grid or random fashion. These LEDs could be of the approximately 660 nanometer spectrum (red), and might also include some 450 nanometer spectrum (blue) spectrums as commonly used in plant-growth illumination units. Other spectrums may also be used. White LEDs could also be used if the user dislikes the red color; however, growth rates might be less because white LEDs do not contain as much red spectrum. As an alternative to a grid pattern of several LEDs or other illumination sources, fewer LEDs (or a single one) might be placed in the center of the appendage area, and a lens, prism, or diffuser used to spread the illumination. If an upflow embodiment, the gas bubbles themselves could be used for an illumination diffuser. Generally, if an embodiment uses higher power illumination sources (especially point sources), the sources will be positioned farther apart than lower power sources would be. For example, one embodiment places two 3-watt LEDs approximately 5 cm apart (center to center). Another embodiment utilizes compact fluorescent (CFL) bulbs, especially CFL “floodlight” bulbs which have built-in reflectors. Small embodiments might only utilize a single CFL bulb, whereas larger embodiments might have several bulbs spaced apart from one another. For example, a waterfall embodiment has a macroalgal attachment material area with a width of 50 cm and a height of 30 cm, and 12 total CFL bulbs: 3 rows of 4 bulbs each, with each bulb being 15 watts for a total of 180 watts. The spectrum of these CFL bulbs is 2700 k. Other spectrums up to 6500 k, however, have been utilized with useful results. Thus any already-available source of illumination can be used so long as it is of sufficient wattage and the proper spectrum to grow the attached macroalgae on the attachment materials. Co-pending international application PCT/US12/51040, which is incorporated herein by reference, discloses many useful automatic control functions for an illumination means.

The illumination and the flowing water must reach and be in direct contact with the attachment materials so as to provide the benefits of turbulence and nutrient delivery to the growing algae. This becomes even more important as algal growth thickens on the surfaces; the growth will tend to route the water flow away from the attachment material and any method that redirects the flow back towards the attachment material will improve growth performance by insuring that the roots of the algae continue to receive turbulence, nutrient delivery, and penetration of illumination. With more illumination and water flow reaching the algal “roots” that do the attaching, the growth can go for longer periods without the roots dying, detaching, and causing loss of filtering or seaweed cultivation. This longer growth period will allow the algae to grow to a longer length, which will “reach out” farther into the illumination and water flow, thus creating more contact area for metabolite transfer, similar to how a taller radio antenna can receive more signals. This longer length, however, pulls much harder on the roots and thus the roots must remain alive so as to continue to hold on to the attachment materials.

The solid attached macroalgae that grow on the surfaces must be removed (harvested) in order for the nutrients to be removed from the water, or in order to provide the cultivated seaweed that is desired. With prior art planar attachment surfaces, harvesting had often been accomplished by removing the attachment material from the algae scrubber unit, scraping the algae off, and then replacing the material back into the algae scrubber for more growth to occur. However, the current invention makes possible an easier method of harvesting, whereby a “comb” apparatus (or the user's fingers) are “combed” along the appendages, much like one would comb their hair, so as to harvest algal growth from the appendages. The harvesting comb's teeth would approximately match the size of the appendages being combed, and could travel downwards in a waterfall embodiment or upwards in an upflow embodiment. This could be accomplished using just one hand of the user and would not require removal of the appendages. Attempting a similar “combing” of prior art planar surfaces such as a waterfall, especially if done one-handed, results in the displacement of the material to one side or another which evades the user.

In addition, as previously discussed, the prior art planar attachment surface suffers from light blockage in its middle portion because this section does not benefit from side-illumination. Thus, many times while lifting a planar surface out of the water, the growth will fall off of a section in the center which is usually the section with the thickest growth (and which blocked the most illumination). The section of planar surface where the algae falls off will show a light-brown wheat looking growth, which is actually dead algae. Dead algae has no strength and thus lets go of the green growth on top of it. These planar surfaces have approximately a 1:1 ratio of illumination area to root-attachment area, which is the lowest possible.

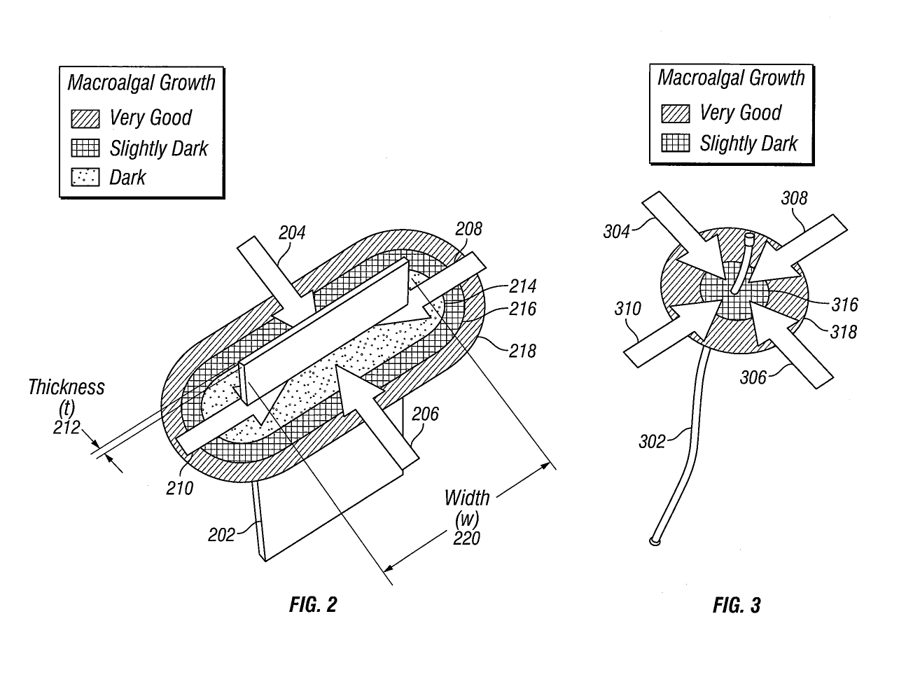

FIG. 2 illustrates a perspective view of one embodiment of an appendage that can be used in a scrubber or seaweed cultivator. In this embodiment, appendage 202 is a “ribbon” shaped attachment appendage. Appendage 202 is considered a ribbon shaped appendage because it has a thickness 212 and a width 220, and width 220 is much narrower than the prior art planar surface. As such, appendage 202 allows some illumination from the sides in directions 204, 206, 208 and 210 to penetrate into the center section, thus giving the center section more illumination than the prior art planar surface. Thus, the ribbon shaped appendage 202 has a higher ratio of illumination area to root area than prior art planar surfaces do; the narrower the ribbon is, the more side-illumination 208 and 210 is available to the root attachment area in its center, and thus the more days the algae can grow before dying and detaching from lack of illumination.

The bands 214, 216 and 218 surrounding appendage 202 represent a cross-section of algal growth on the surface of appendage 202, and the large arrows 204, 206, 208 and 210 represent the penetration of illumination into that growth. The “macroalgal growth” legend represents levels of darkness of the bands which represent the growth state of the algae: furthest from appendage 202 is new growth 218 that has not been grown-over yet; as you move in further towards the attachment material 202, however, the legend represents darker growth 216, and even further darker growth 214, which has been shaded by the newer outer growth. Nevertheless, appendage 202 receives illumination strongly in at least two directions 204, 206, and slightly less strongly from two additional directions 208, 210, thus the algal roots survive longer along the entire width 220 and even the innermost section of algae remains alive longer.

FIG. 3 illustrates a perspective view of another embodiment of an appendage for use in a scrubber or seaweed cultivator. In this embodiment, appendage 302 is a cylindrically shaped appendage (e.g., a narrow string) with essentially zero width compared to a prior art planar surface, and has the highest ratio of illumination area for the algae (algae is a fixed thickness of growth all the way around the appendage) compared to the root area which is just a “point”. Thus, from an illumination perspective, the smaller the diameter appendage 302 is, the more open area there is for illumination to penetrate. In this aspect, appendage 302 can be illuminated from each of directions 304, 306, 308 and 310. There is a practical limitation, however, because smaller diameter appendages will tangle more readily, and may thus need more distance from nearby appendages if they have long lengths.

Similar to FIG. 2, in FIG. 3, the bands 316, 318 surrounding appendage 302 represent a cross section of algal growth on the surface, and the large arrows 304, 306, 308 and 310 represent the penetration of illumination into that growth. The “macroalgal growth” legend represents levels of darkness of the bands which represent the growth state of the algae: furthest from appendage 302 is new growth 318 that has not been grown-over yet; as you move in further towards the attachment material 302, however, the legend represents a slightly darker growth 316. Due to the size and shape of appendage 302, appendage 302 receives strong illumination from all directions, and has the highest illumination ratio, thus allowing the roots to survive for the longest periods of time.

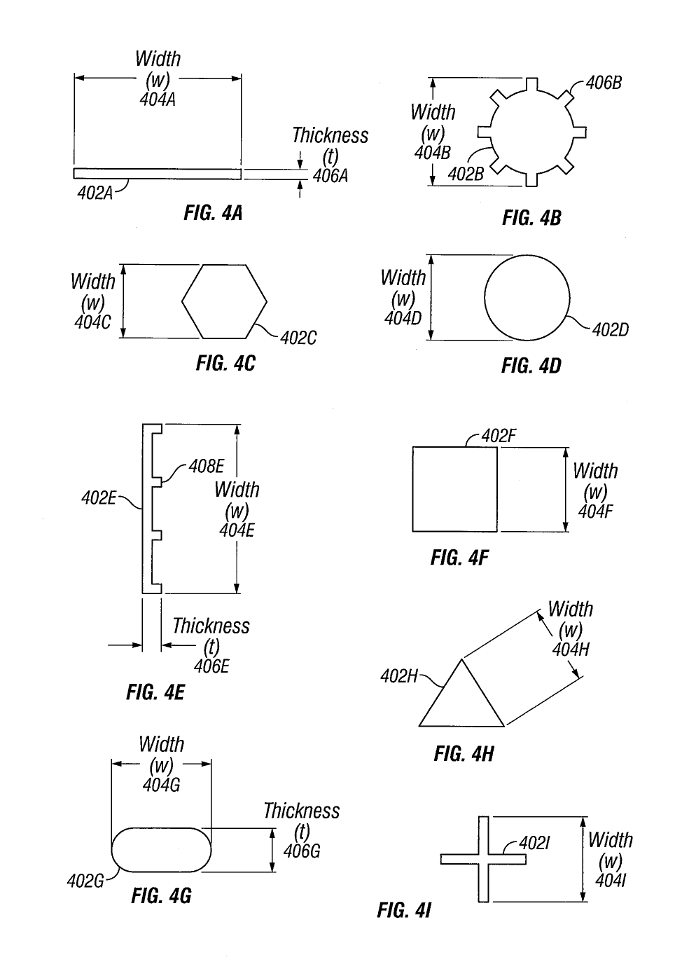

FIGS. 4A-4I show several possible cross-sectional shapes of appendages for use in a scrubber or seaweed cultivator. Representatively, FIG. 4A shows a ribbon shaped appendage 402A having a width 404A greater than its thickness 406A. FIG. 4B shows a round shaped appendage 402B having a width 404B and ridges 406B extending from sides of appendage 402B. FIG. 4C shows a hexagon shaped appendage 402C having a width 404C. FIG. 4D shows a round shaped appendage 402D having a width 404D. FIG. 4E shows a ribbon shaped appendage 402E having a width 404E greater than its thickness 406E and ridges 408E extending from one side of appendage 402E. FIG. 4F shows a square shaped appendage 402F having a width 404F. FIG. 4G shows an oval shaped appendage 402G having a width 404G greater than its thickness 406G. FIG. 4H shows a triangle shaped appendage 402H having a width 404H. FIG. 4I shows a cross shaped appendage 402I having a width 404I. Other shapes are also possible. Appendage cross sections can be any shape in addition to the illustrated shapes and can have small ridges or slots on them if desired. If the ridges are small in comparison to the overall thickness of the appendage, then the thickness can be measured from the tips of the ridges. If the ridges are large, such as the shape in FIG. 4I, then they can be treated as two ribbons. In some embodiments, any of the appendages disclosed herein may have a maximum width of about 50 mm or less, or about 20 mm or less, or about 10 mm or less, for example about 5 mm or less. In addition, a maximum width of any of the appendages disclosed herein may be no greater than 50 times its thickness, or no greater than about 20 times its thickness, for example, no greater than 10 times its thickness.

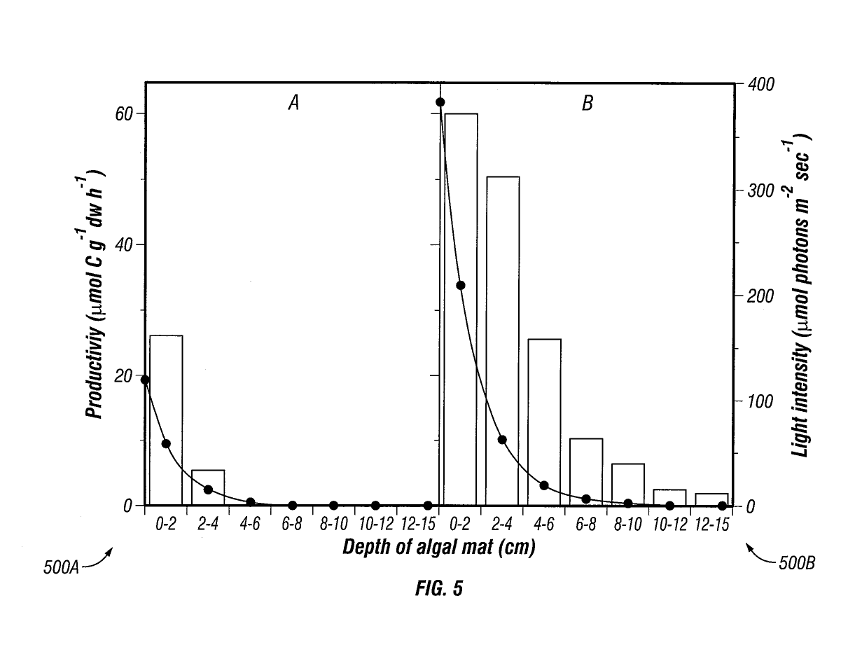

FIG. 5 is a graph comparing the effects of self-shading of the “chaetomorpha” species of green algae, which is one of the types of macroalgae which commonly grows in saltwater algae scrubbers. The left vertical axis shows productivity (rate of growth per hour) depending on the depth within the algae, and the right vertical axis shows the intensity of illumination within the same algae. The first graph 500A (representing low illumination) shows that illumination which starts out at a level of 120 at the surface of the algae is reduced to approximately 30 at a depth of 20 mm within the algae, which is a reduction of 75 percent. The same first graph 500A also shows that the productivity (rate of growth) starts out at 20 at the surface of the algae but is reduced to 5 at a depth of 20 mm, which is also a reduction of 75 percent. The second graph 500B (representing high illumination), shows that illumination which starts out at a level of 380 at the surface of the algae is reduced to approximately 115 at a depth of 20 mm within the algae, which is a reduction of 70 percent. The same graph 500B shows that productivity (rate of growth) starts out at 62 at the surface of the algae but is reduced to 18 at a depth of 20 mm, which is also a reduction of approximately 70 percent. These reductions in illumination and productivity, which are based on algal thickness, are the basis of the present application.

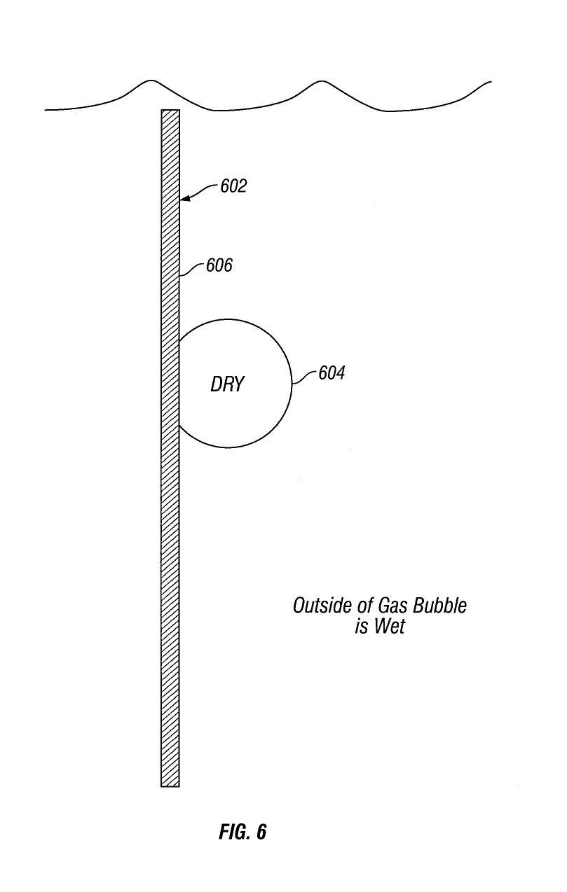

FIG. 6 shows a cross section of an appendage for a scrubber or seaweed cultivator in water. In this embodiment, a gas bubble 604 is traversing up a growth surface 606 of the appendage 602 while in contact with and rubbing the growth surface 606. The concept of gas bubbles needing to be in physical rubbing contact with the appendage, as opposed to just “near” the material, is central to the operation of all of the upflow embodiments described herein. Only if the gas bubbles physically rub the material will they impart the “wet, dry, wet, dry” action to the attached macroalgae due to the insides of the gas bubbles being dry. Also, the turbulence of the gas bubbles breaks up the boundary layer of nutrients surrounding the algae (thus allowing more metabolite transfer into and out of the algae), and also supplies CO2 to the algae. Lastly, the gas bubbles provide optical diffusion of the illumination source so as to distribute the illumination more evenly across the attachment material.

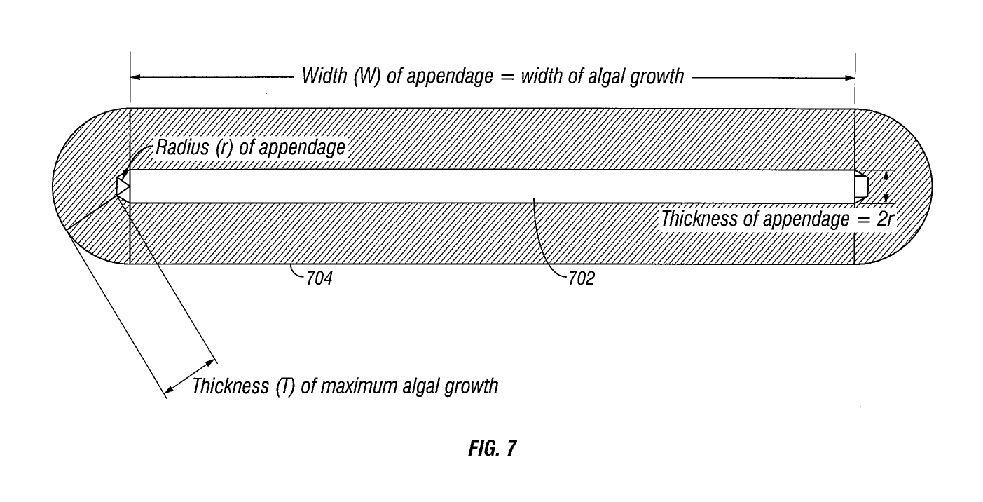

FIG. 7 shows a top plan view of one embodiment of an attachment appendage for a scrubber or algal cultivator surrounded by a thickness “T” of algal growth. In this embodiment, appendage 702 is a ribbon shaped appendage that has a width “W”, and a thickness with an edge of radius “r”. The “Illumination Ratio” is defined as the ratio of the circumference of the outer edge of algal growth 704 to the circumference of the surface of the attachment appendage. This is because the more space the algae strands have to spread out (like branches on a tree), the more the algal strands will allow illumination (and water flow) to reach the “roots” that are attached to the attachment material underneath, thus keeping the roots alive for a longer number of days. Thus:

Illumination Ratio=(Circumference of Macroalgal Growth)/(Circumference of Attachment Area)=[2W+2(pi)(r+T)]/[2W+2(pi)(r)]

If the width W=0 as it would in the case of a cylindrical appendage (rod, rope or string) with diameter D, then the equation simplifies to:

Illumination Ratio=1+2T/D

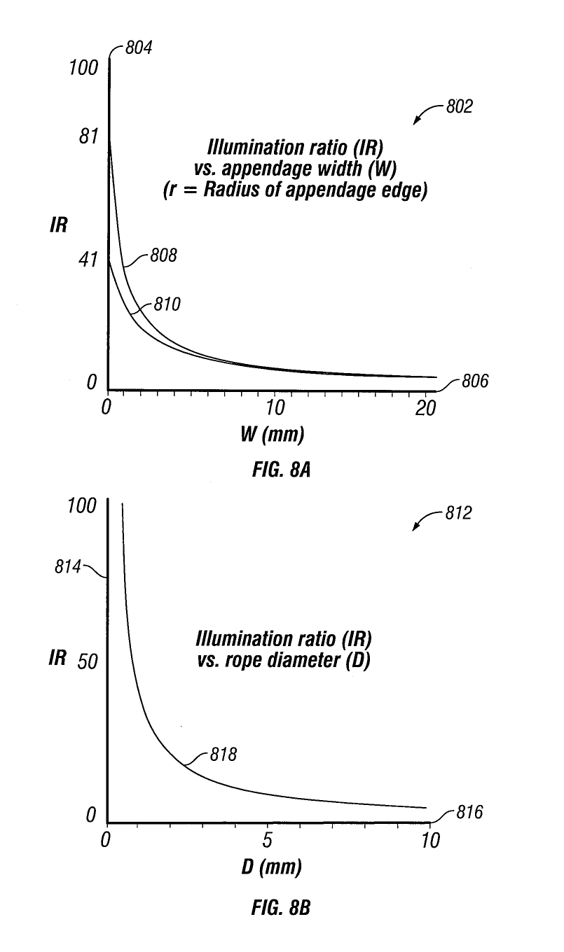

FIG. 8A and FIG. 8B illustrate graphs showing exemplary illumination ratios. In particular, FIG. 8A shows graph 802 representing the Illumination Ratio (IR) vs. appendage width and FIG. 8B shows graph 812 representing the IR vs. rope diameter. Returning to FIG. 8A, graph 802 shows the IR plotted for a ribbon attachment appendage with a variable width W ranging from 0 to 20 mm, and for a first ribbon 808 having a thickness of 0.5 mm (r=0.25 mm), and a second ribbon 810 having a thickness of 1.0 mm (r=0.5 mm). The y-axis 804 represents the IR and the x-axis 806 represents appendage width (W). The thickness of growth is assumed to be 20 mm (T=20) as it commonly is with saltwater upflows. It can be seen here how the IR increases greatly as the width W gets smaller, especially in the 1 and 2 mm width areas. And the smaller thickness ribbon 808 (r=0.25) has a higher IR at all widths compared to the larger thickness ribbon 810. Zero width (W=0), of course, is equivalent to a cylindrical rod, rope or string which would have the highest IR; this is plotted in graph 812 of FIG. 8B in which the y-axis 814 represents IR and the x-axis 816 represents appendage diameter (D). In FIG. 8B it can be seen from line 818 that the diameter D of the rod, rope or string increases up to 10 mm. Interestingly, the IR does not really start increasing until the diameter D is less than about 5 mm, which indicates that appendages thicker than about 5 mm, and certainly thicker than 10 mm, have about the same illumination functionality as any other larger size appendage. Only very small diameter appendages work well in this regard. This is because from the point of view of a strand of algae (whose size is small and does not change), a larger appendage starts to appear as a solid wall, and the strand of algae cannot “see” behind the appendage; thus, the algae cannot receive illumination from behind the appendage. However, a very narrow appendage (e.g., a string) appears very thin to a strand of algae, and thus the algae can “see” behind the string because it is so narrow and thus can receive illumination from behind the string as well as in front of it and to the sides of it. The IR of a planar surface is of course 1, because the illumination area equals the planar surface area.

The thickness of growth T varies according to the type of water and the embodiment of algae scrubber or seaweed cultivator. Generally, there are four thicknesses that the macroalgae will attain before requiring harvesting: saltwater generally grows coarser, more three-dimensional algae which supports itself a bit more and therefore attains a greater thickness than freshwater growth does; upflow embodiments, because they are submerged and have a body of water surrounding (“floating”) the growth, tend to have thicker growth than do waterfalls which “matt down” more due to the lack of being supported by a body of water. Therefore, the thickness values “T” are:
Saltwater upflow: T=20 mm
Saltwater waterfall: T=10 mm
Freshwater upflow: T=10 mm
Freshwater waterfall: T=5 mm
(waterfall includes horizontal sloped “rivers”)

It is at these average thicknesses that the growth is deemed to be the maximum that generally can be reached in a typical harvesting period of 7-21 days before sufficient illumination can no longer keep the algal roots alive and attached. However, these thickness numbers are just averages of all types of attachment materials; the present invention introduces fine-tuning of these numbers based on the Illumination Ratio of a given attachment material. A material with a higher IR than a planar surface will be able to hold on to the growth longer (and be able to grow for longer periods) because it allows more illumination to reach the roots and thus can be given extra distance between appendage surfaces, whereas a planar surface should slightly reduce these distances. So the IR is used in an equation “M” to modify the radius of growth: M=0.0064 (IR)+0.718. The “M” modifier generally varies from about 0.72 for a planar surface to 1.24 for thin fishing line. Thus, the modified distance between appendage surfaces would be twice the modified thickness of growth: Distance=2T(M). The final equation determining the distance between appendage surfaces is thus:

Distance=2T [0.0064([2W+2(pi)(r+T)]/[2W+2(pi)(r)])+0.718]

Per the above Distance equation, some representative appendage materials and their approximate distances between appendage surfaces are (rounded to nearest mm):
1.2 mm tennis racquet string in saltwater upflow: 37 mm
1.2 mm tennis racquet string in saltwater waterfall: 17 mm
1.2 mm tennis racquet string in freshwater upflow: 17 mm
1.2 mm tennis racquet string in freshwater waterfall: 8 mm
0.5 mm thin fishing line in saltwater upflow: 49 mm
0.5 mm thin fishing line in saltwater waterfall: 20 mm
0.5 mm thin fishing line in freshwater upflow: 20 mm
0.5 mm thin fishing line in freshwater waterfall: 9 mm
6 mm rope in saltwater upflow: 31 mm
6 mm rope in saltwater waterfall: 15 mm
6 mm rope in freshwater upflow: 15 mm
6 mm rope in freshwater waterfall: 7 mm
2 mm resilient rod in saltwater upflow: 34 mm
2 mm resilient rod in saltwater waterfall: 16 mm
2 mm resilient rod in freshwater upflow: 16 mm
2 mm resilient rod in freshwater waterfall: 8 mm
4 mm by 0.5 mm thick packaging ribbon in saltwater upflow: 32 mm
4 mm by 0.5 mm thick packaging ribbon in saltwater waterfall: 15 mm
4 mm by 0.5 mm thick packaging ribbon in freshwater upflow: 15 mm
4 mm by 0.5 mm thick packaging ribbon in freshwater waterfall: 7 mm
12 mm by 2 mm thick packaging ribbon in saltwater upflow: 30 mm
12 mm by 2 mm thick packaging ribbon in saltwater waterfall: 15 mm
12 mm by 2 mm thick packaging ribbon in freshwater upflow: 15 mm
12 mm by 2 mm thick packaging ribbon in freshwater waterfall: 7 mm

In still further embodiments, a distance between appendage surfaces may vary within a range of from about 200 mm to less than about 5 mm, for example, the distance between appendage surfaces may be 200 mm or less, less than 100 mm, less than 50 mm, less than 40 mm, less than 30 mm, less than 20 mm, less than 10 mm or less than 5 mm.

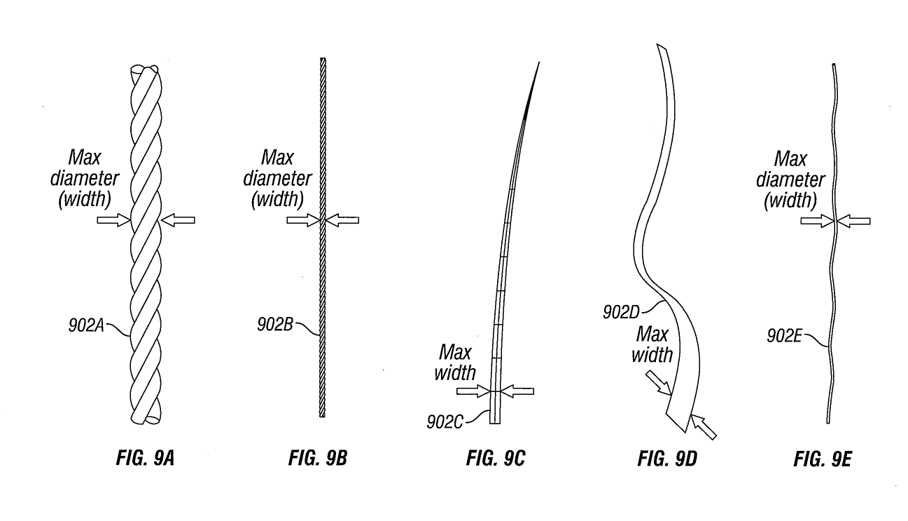

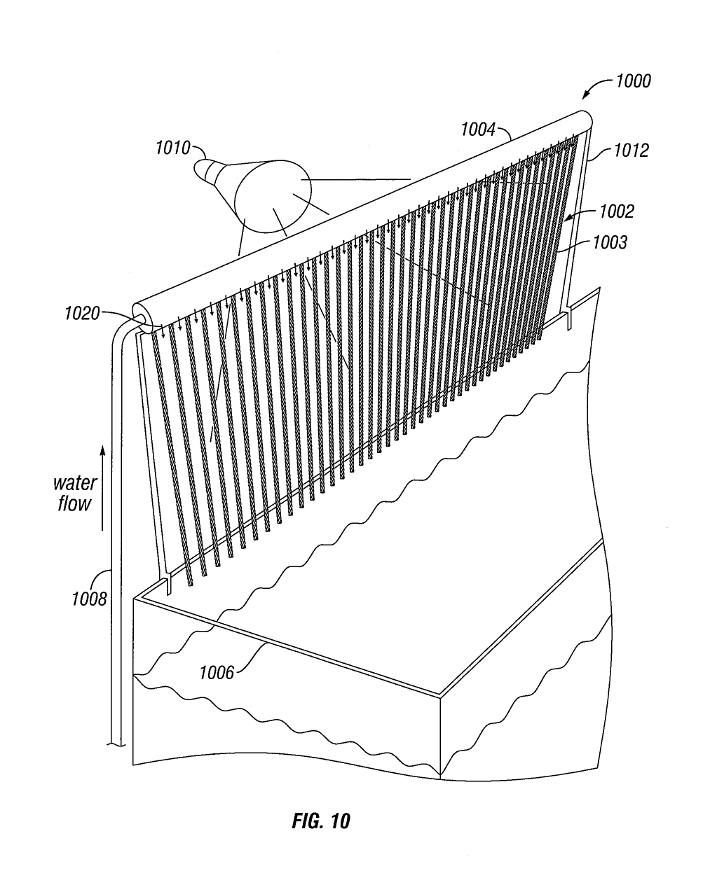

FIG. 9A-FIG. 9E illustrate embodiments of different types of appendages for use in a scrubber or seaweed cultivator. FIG. 9A illustrates an appendage 902A made of a thick rope, which has a low illumination ratio. FIG. 9B illustrates an appendage 902B made of a thin rope, which has a higher illumination ratio than appendage 902A. FIG. 9C illustrates an appendage 902C made of a sturdy ribbon. FIG. 9D illustrates an appendage 902D made of a flexible ribbon 902D. FIG. 9E illustrates an appendage 902E made of a string, which has the highest ratio of all the appendages shown in FIGS. 9A-9E. Of particular interest is the variation in diameter of the cylindrical materials; using the IR equation 1+2T/D, a thin string (e.g., appendage 902E) would have the highest IR. This concept is the opposite of established thinking, where it is assumed that a larger attachment surface gives more surface area to attach and grab on to. More surface area may be good for giant algae such as kelp, but for green hair algal species, smaller is better because of the very small (only up to 20 mm) illumination penetration depths as is commonly the case in algae scrubbers (again, see illumination depth penetration of FIG. 5). Two types of ribbons, sturdy (e.g., appendage 902C) and flexible (e.g., appendage 902D), are also shown; sturdy ribbons will stand upright on their own in upflow embodiments without gas bubbles or water movement needed, whereas flexible ribbons will require flowing water or gas bubbles to support them. Both are useful. In addition to the above IR equations, it is also envisioned that more elaborate equations could be constructed by incorporating the proximity effect of one appendage to another (shading, flow blocking, nutrient consumption), the length of the appendage (nutrient gradient), gas flow (upflows), water flow (waterfalls), illumination, appendage material, and ramp-up time to full growth.

FIG. 10 shows a perspective view of one embodiment of a linear waterfall algae scrubber over a container of water. In some embodiments, scrubber 1000 is positioned over a tank 1006 of water by bracket assembly 1012. Scrubber 1000 may include growth appendages 1002 extending from a support member 1004 attached to the bracket assembly 1012. Support member 1004 may be any type of water delivery structure having water outlets such that water may be pumped into support member 1004 through hose 1008 and then out the outlets onto appendages 1002 in a downward direction, as illustrated by arrows 1020. Representatively, support member 1004 may be a tube, housing, open-trough structure or the like. Appendages 1002 may be coupled to support member 1004 by any suitable mechanism, for example, a friction fit coupling mechanism, bolts, brackets, screws, chemical adhesive or the like. Regardless of the coupling mechanism, appendages 1002 may be linearly placed along support member 1004 and evenly spaced according to any of the previously discussed parameters near a water outlet such that they receive a flow of water.

In some embodiments, growth appendages 1002 are flexible ropes. It is contemplated, however, that growth appendages 1002 could also be rods, ribbons or strings. Any number of growth appendages 1002 suitable for algal growth may be attached to support member 1004. Water is supplied to appendages 1002 by the waterfall delivery means which could be a tube, housing, open-top trough, or any other means of supplying water. Water is delivered to the support member 1004 by a pump attached to hose 1008, or by an overflow from a body of water above. Water is then allowed to flow downwards over a growth surface 1003 of appendages 1002 via overflowing from support member 1004 (in the case of a trough), or via ports in support member 1004. Water then flows down appendages 1002 while adhering to appendages via surface tension. An illumination source 1010 is positioned on one or both sides of appendages 1002 and enables photosynthesis for macroalgae to attach to and grow on appendages 1002. In one embodiment, the appendage number, length, and distance between appendage surfaces, may be 7 appendages of 5 mm diameter, 200 mm length, and spacing of 40 mm between appendage surfaces as measured at the anchoring points at the top of the ropes. In this embodiment, water flow would be approximately 1800 lph, which would be sufficient to saturate thick algal growth with flow on all appendages. Illumination source 1010 could be solar, or at least 96 total fluorescent watts (48 watts each side), or 48 total LED watts (24 watts each side). This size of the filter can provide filtering to handle about 8 typical frozen cubes (8 cc) of food per day.

Such a waterfall scrubber 1000 could be productively used inside a growth compartment 300 mm long; the width of the compartment need only be enough to contain the growth on either side of the appendages, e.g., up to 10 mm on each side of the 5 mm appendages, for an approximate total width of 25 mm. The compartment width could be wider, however, in order to allow easier access for harvesting and cleaning. Such wider-sized embodiments are often required for filtering in the sumps of large aquariums, or for koi ponds. For non-enclosed linear waterfall embodiments, e.g., when the scrubber is above a small pond, the span (number of appendages) could be much more—as long as needed to provide enough filtering—or to span the pond from one side to the other. Such numbers of appendages would be suitable for commercial food (seaweed) cultivation, where the span can be several meters. Linear embodiments, whether waterfall or upflow, can span as much distance as required because illumination (especially if solar) should always be able to reach the appendages. This is as opposed to non-linear embodiments where illumination from the sides (like a car's headlights pointing into a forest) will only fully illuminate the outside appendages.

In some embodiments, scrubber 1000 may be contained in a translucent or transparent compartment. One embodiment for such an application is a linear waterfall scrubber with 3 mm diameter woven polypropylene strings that are 120 mm long, with 20 mm distance (algal thickness “T”=10 mm) between appendage surfaces, and spanning an approximately 200 mm long compartment that is 23 mm wide (10 mm on each side of a 3 mm appendage), and which is side-illuminated by 18 watts of 660 nm LEDs (9 watts per side), and which is also supplied with 1200 lpm of water flow. As in the previous example, the narrow compartment keeps the growth from getting thicker than 10 mm from the appendage surface on each side, which helps keep the roots from losing flow and illumination. Harvesting is done with a comb apparatus that is fitted to the size of the appendages and to the width of the compartment. This size of the aquarium filter can provide filtering to handle about 3 typical frozen cubes (3 cc) of food per day.

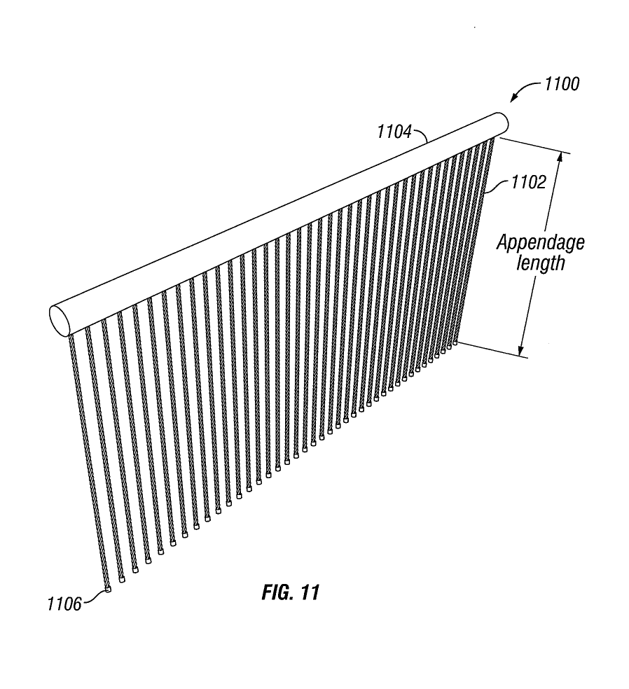

FIG. 11 illustrates a perspective view of another embodiment of an algae scrubber. In this embodiment, algae scrubber 1100 may be a waterfall or upflow scrubber. Scrubber 1100 includes appendages 1102 attached to and extending from support member 1104. Support member 1104 and appendages 1102 may be substantially similar to support member 1004 and appendages 1002 described in reference to FIG. 10, except in this embodiment, weights 1106 are attached to the end of each of appendages 1102. Weights 1106 help to keep appendages 1102 straight and therefore the appendages 1102 could be placed closer together; as long as weights 1106 are no larger in diameter than appendages 1102, they will still be able to be comb harvested in one continuous downward motion.

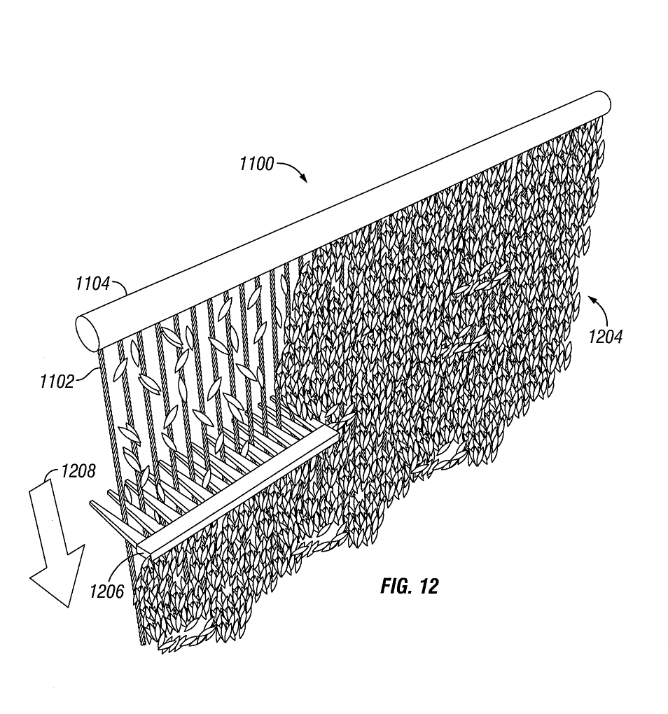

FIG. 12 illustrates a perspective view of one embodiment of a linear waterfall scrubber such as that of FIG. 10 or FIG. 11, with macroalgal growth and a harvesting comb. Representatively, scrubber 1100 includes appendages 1102 extending from support member 1104 as previously discussed, with macroalgal growth 1204 on appendages 1102. One of the main advantages of appendages such as rods, ropes, ribbons or strings is that they can be harvested with a comb 1206, even by one hand of the user; planar attachment surfaces which couple to a single support, by comparison, cannot easily be harvested with one hand because the planar surface will move away from the user if the user applies pressure to one side of the surface. When harvesting is desired in the apparatus in this drawing, the entire apparatus can first be relocated to a harvesting area, or a catchment (not shown) can be placed below the apparatus. The harvesting comb 1206 can then be used to push macroalgae 1204 off of the appendages 1102 in direction 1208. This comb-harvesting procedure can also be mechanically automated such as a built-in comb with a lever that is pushed down by the user. It is also important to note that, in this embodiment, none of the appendages are connected together because doing so would prevent one-motion comb harvesting.

Another advantage of the appendages of the current invention is the inherent “partial harvesting” that results many times from the comb-harvesting method. Since the comb only touches two sides of a given appendage, the remaining sides retain a certain amount of attached algal growth after the comb passes. This remaining growth can be seen in FIG. 12. This is in contrast to planar harvesting methods where a flat scraping device is used to scrape algae off. If the flat scraper is pressed down into the surface, little if any algal growth will remain, especially if the planar surface has no holes. Harvesting all the growth may be useful in some situations such as dark or black growth, or to extend the amount of time before the next harvest, but once green hair algae is growing it is generally advantageous to leave some algae to speed up the next growth/filtration cycle.

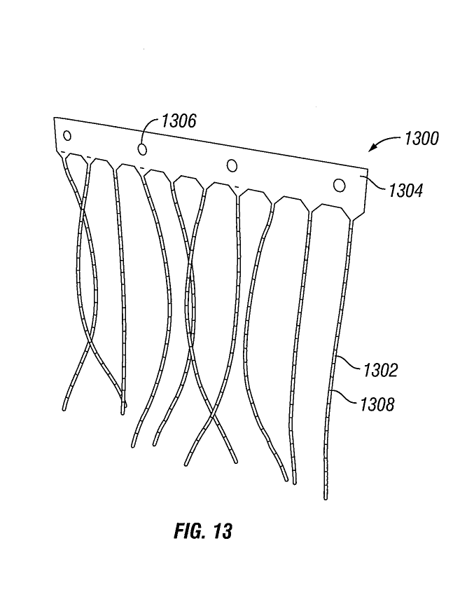

FIG. 13 illustrates a perspective view of another embodiment of a waterfall scrubber. In this embodiment, scrubber 1300 includes a support member 1304 with appendages 1302 connected to, and extending therefrom. Appendages 1302 and support member 1304 may be a one-piece molded version of a linear waterfall embodiment, using a single sheet of moldable plastic or rubber which has the appendages cut and molded into cylindrical shapes with roughness 1308 added. Roughness 1308 may be, for example, cuts, indentations or protrusions formed along the growth surface of appendages 1302. Support member 1304 may also be cut from the same sheet. This type of embodiment is a low-cost replacement for prior art waterfall planar attachment screens, and can be used just as readily for an upflow embodiment. In some cases, support member 1304 may further include mounting holes 1306 to facilitate mounting of scrubber within or above, for example, a water tank such as that previously discussed.

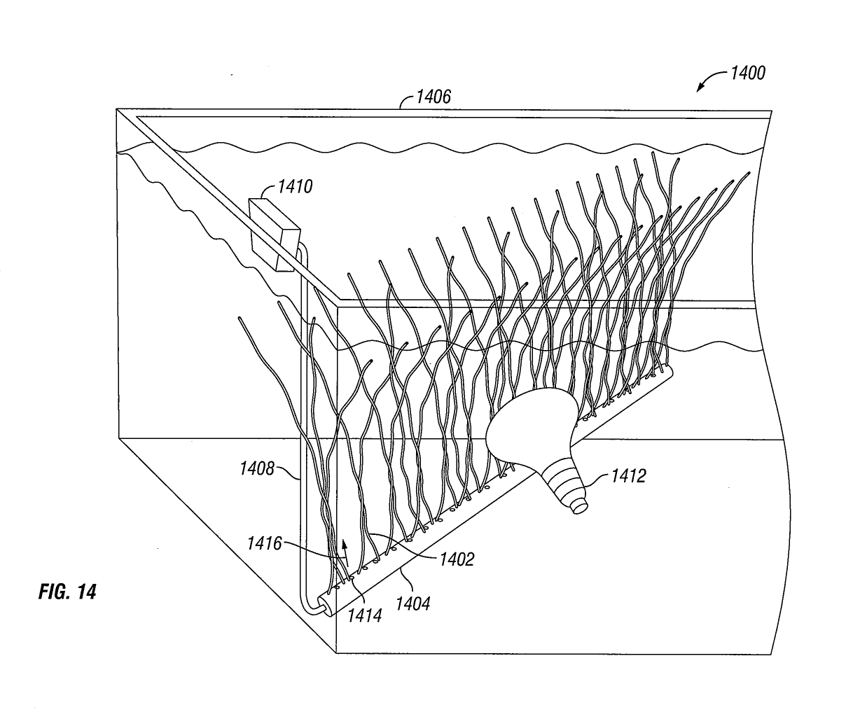

FIG. 14 illustrates a perspective view of an embodiment of a linear upflow scrubber. Scrubber 1400 may be positioned within a bottom of a water tank 1406, within which water filtration or macroalgal growth cultivation is desired. Similar to previous embodiments, scrubber 1400 may include a support member 1404 with appendages 1402 attached to, and extending therefrom. Appendages 1402 may be stiff string or woven rope type appendages. In this case, however, since scrubber 1400 is positioned within the water, support member 1404 further includes outlet ports 1414 through which air can be pumped out to create air bubbles along appendages 1402. Any number of appendages suitable for algal growth may be positioned along support member 1404. Since the appendages 1402 are anchored in a non-repeating pattern, there is not a fixed distance between appendages surfaces. Therefore an average can be taken of several (or all) of the distances between appendage surfaces. Also, since appendages 1402, in this case, are very narrow, they can be assumed to be of zero diameter for the purpose of determining this average distance. Of importance here is that appendages 1402 are discrete and not connected to each other, although they clearly are touching each other at some points. Once appendages 1402 leave the anchoring points at the bottom, they are separate entities, which allows the easy one-motion harvesting to be done from the bottom upwards without having to work around knots, connections, etc., which would take more time and would be difficult to see when overgrown with algae.

The gas bubbles may be delivered to appendages 1402 according to any technique or apparatus which supplies gas bubbles to the water touching appendages 1402 such that the gas bubbles traverse up appendages 1402 while staying in contact with appendages 1402. For example, in the illustrated embodiment, gas bubbles are pumped from pump 1410 attached to tank 1406 and through a hose 1408, which is connected to support member 1404. Support member 1402 is a substantially hollow tube having outlet ports 1414 formed through the wall, near appendages 1402. Thus, when gas is pumped through hose 1408, it is output to appendages 1402 through outlet ports 1414 in an upward direction as illustrated by arrow 1416. In another embodiment, a bubble plate with gas passages that lead to a gas supply beneath could be positioned near appendages 1402 to supply bubbles along appendages 1402. Another embodiment may include a series of individual gas tubes which terminate with open ends beneath the appendages 1402. In still further embodiments, a gas bubble divider or a flexible-orifice bubbler, made using a sliced vinyl air hose could be used. As gas bubbles are emitted by the gas bubbling device, the bubbles traverse up appendages 1402 and deliver water flow, nutrients, CO2 and turbulence to appendages 1402 and any attached algae. When illumination source 1412 applies illumination to either side, both sides, or the top of appendages 1402, macroalgal growth attaches to and grows on the appendages. Typical gas flow rates for small diameter embodiments such as this might be 0.13 lpm of gas for each cm of length of the gas bubble delivery means. Thus, a 200 mm long embodiment could have approximately 2.6 lpm of gas flow pumped into support member 1402 by an external gas pump.

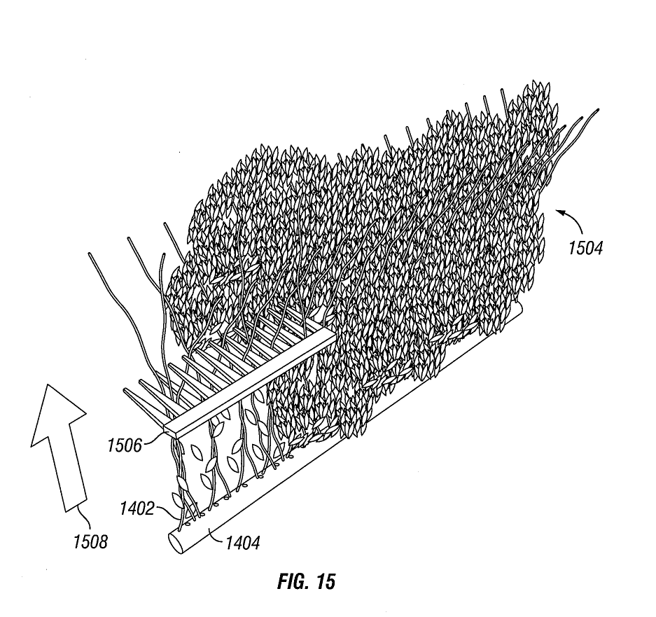

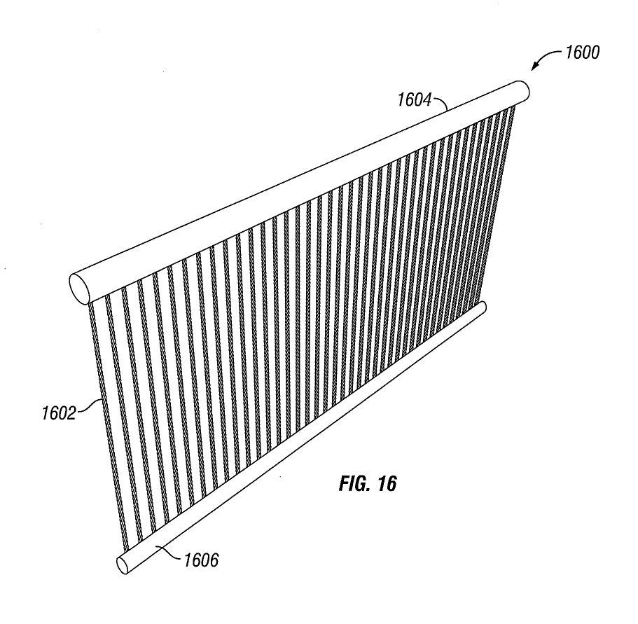

FIG. 15 illustrates a perspective view of one embodiment of the linear upflow scrubber of FIG. 14. In this view, macroalgal growth 1504 is shown attached to appendages 1402. A harvesting comb 1506 may be used to brush appendages 1402 in an upwards direction 1508 so as to harvest a portion of the algae in one upwards motion. The harvesting comb 1506 can be used with the gas bubbles flowing or stopped. Because the surface of the water (not shown) is generally directly above appendages 1402 of this embodiment, the macroalgae 1504 can be combed straight up and out of the water in direction 1508 in one motion, usually with one hand of the user if the embodiment is of a typical home aquarium or seaweed cultivator size. Alternatively, if appendages 1402 are submerged deeper and farther down from the water surface, or if there is some blocking structure above appendages 1402, the harvesting comb 1506 can clamp down on the growth so as to hold it as the growth is brought to the surface, or the comb 1506 can place the growth in a submerged container for movement to the surface. The comb 1506 can be moved along appendages 1402 in a single upwards direction 1508, or can be moved multiple times in multiple directions so as to harvest more.

The harvesting comb 1506 may be a separate structure, or an attached structure which allows movement either manually or automatically along appendages 1402. The “teeth” of the comb 1506 are generally fitted to the density and diameter of appendages 1402, such that a large portion of the attached macroalgal growth 1504 is removed by passing comb 1506 upwards through appendages 1402. Since comb 1506 only contacts two sides of a given appendage 1402, some algae remain attached to appendage 1402 as shown in the drawing. This is an advantage in speeding up the re-growth process after harvesting. The comb 1506 can be made of any material which harvests sufficient algae from appendages 1402 without damaging appendages 1402, especially if appendages 1402 are coated with a roughening texture. Such comb material might be plastic, rubber, wood, steel, or a combination of these. A rubber-coated comb might be used to protect roughening textures. The teeth of the comb can be straight (parallel), or can be angled/pointed as shown in the drawing. Multi-layer combs could also be used whereby the first layer of teeth to touch the algae is coarse and open (to harvest the largest portions), and successive following layers of teeth are finer and have a tighter fit on the appendages, so as to harvest more and smaller strands of algae with a single combing.

FIG. 16 illustrates a perspective view of another embodiment of a scrubber. In this embodiment, scrubber 1600 may be an upflow scrubber. Similar to previous embodiments, scrubber 1600 includes appendages 1602 attached to, and extending from, a support member 1604. Appendages 1602 and support member 1604 may be substantially similar to any of the previously discussed appendage and support member configurations. In this embodiment, scrubber 1600 further includes a second support member 1606 attached to the free ends of appendages 1602 so that both the top and bottom of the appendages are supported. This is analogous to a rigid rod, in that it cannot tangle, and allows much closer placement of appendages 1602 to each other without requiring stiff rods with protruding ends which might not be suitable for certain environments such as swimming ponds.

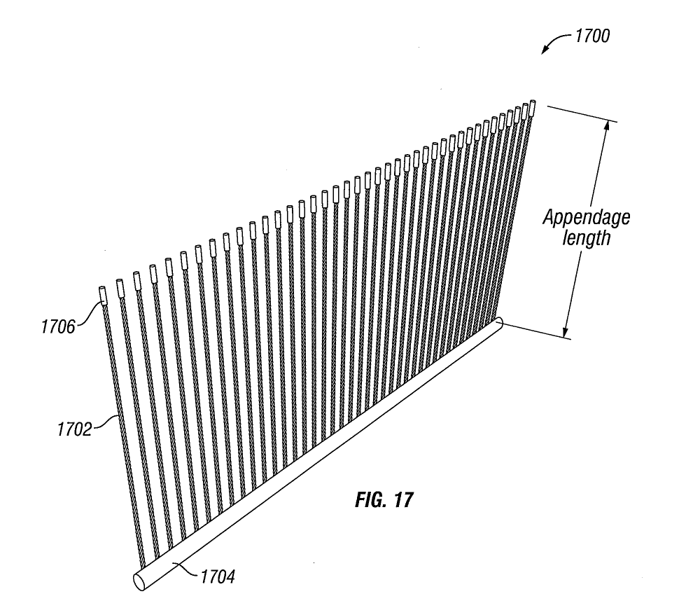

FIG. 17 illustrates a perspective view of another embodiment of a scrubber. In this embodiment, scrubber 1700 may be an upflow scrubber. Similar to previous embodiments, scrubber 1700 includes appendages 1702 attached to, and extending from, a support member 1704. Appendages 1702 and support member 1704 may be substantially similar to any of the previously discussed appendage and support member configurations. In this embodiment, scrubber 1700 further includes buoyant floats 1706 attached to the top loose ends of each appendage 1702. Floats 1706 may be configured to help appendages 1702 stay elongated vertically, and could still allow comb harvesting if they were no larger in diameter than appendages 1702. Floats 1706 could be made of closed cell foam materials, as well as encapsulated gas and attached to appendages 1702 in any suitable manner. The addition of buoyancy may not be needed, however, depending on the degree of rigidity, diameter, material, spacing and length of the appendages. For example, if the appendages are made of 5 mm diameter woven polypropylene rope which are 300 mm long and spaced 100 mm apart, and are placed in rapidly upflowing gas bubbles, they will probably not require additional buoyant floatation attached to their upper ends. However, if the spacing of these appendages is reduced to 50 mm, additional floatation will probably be required, especially with less gas bubble quantities, so as to keep the appendages vertical and to minimize tangling.

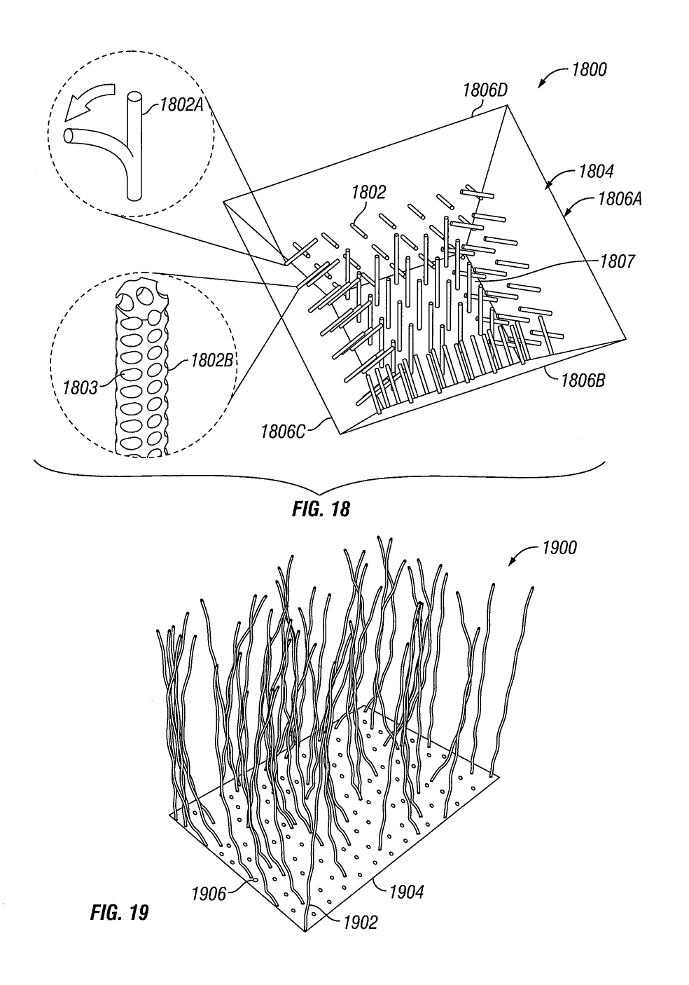

FIG. 18 illustrates a perspective view of one embodiment of an upflow scrubber. In this embodiment, scrubber 1800 includes a non-linear array of appendages 1802 positioned within a growth compartment 1804. Growth compartment 1804 includes walls 1806A, 1806B, 1806C and 1806D extending from a base member 1807 and an open top. Appendages 1802 may be attached to and extend from any one or more of walls 1806A-1806D and/or base member 1807. In some embodiments, it is desirable for appendages 1802 to extend from both walls 1806A-1806D and base member 1807 because the side appendages 1802 can overlap and touch the bottom appendages 1802 and not cause the harvesting comb to get stuck. Appendages 1802 can, in some embodiments, extend above the water surface (not shown), or can be kept beneath the water surface. Since rapid upflowing gas bubbles will effectively elevate the macroalgae above the static waterline, the elevated appendages will give additional surfaces for the algae to grow on, but will still allow loose debris (detached algae, livestock, etc.) to “bubble over” appendages 1802 so as to not get stuck. Appendages 1802 can be attached to the growth compartment 1804 with any suitable attachment means, including glue, friction fit, peg and hole, plastic welding, plastic nuts, other means, or any combination thereof; or appendages 1802 could be part of the same homogenous piece of material used to make the growth compartment 1804 and thus would be caused to extend out during the fabrication process. Appendages 1802 could also be made to be adjustable by the user, by sliding appendages 1802 through the compartment walls, or by telescoping part of appendages 1802.

In some embodiments, appendages 1802 are rigid appendages while in other embodiments, appendages 1802 are resilient appendages as illustrated by the exploded views in FIG. 18. Rigid and resilient appendages are self-supporting, and are good choices for very shallow upflow embodiments where there is not much vertical room for uprising gas bubbles to “pull” up the appendages or for the floatation of the appendage material to have much buoyant effect. In deeper embodiments which might be difficult for the user to easily reach, rigid and resilient appendages have the advantage of not getting tangled easily and thus not requiring extra user involvement.

In the case of a resilient appendage 1802A, the appendage is normally straight but has been deformed to the left by an external force (not shown), and this movement is depicted by the large curved arrow in the exploded view of FIG. 18. When the external force is removed, the appendage will move in the opposite direction and return to its original position. Materials such as neoprene, nitrile, polyurethane, fluorosilicate, nylon, polyethylene, polypropylene, vinyl, EPDM, polystyrene, viton, butyl, thin PVC, other materials, or any combination thereof can be used for the resilient appendages; the length and thickness of the appendages can be tailored to the size of the growth compartment. For example, one embodiment uses 2 mm diameter white nylon resilient appendages of 40 mm length which are oriented vertically and are spaced 20 mm from appendage surface to appendage surface in a grid pattern. The appendages' surfaces are roughened up so as to provide better algal attachment, however, the appendages could also be coated with textures as described later in this application. When algae is harvested from the appendages, either by hand or with a harvesting comb, the appendages will flex in the direction of the harvesting movement and will return back to their original position afterwards.

A rigid appendage 1802B is further illustrated in the exploded view of FIG. 18. In this embodiment, the appendage has micro-holes 1803 going crossways through the appendage, so as to give algae stronger attachment points. These holes 1803 could be drilled or molded and they could be any direction; they somewhat resemble “Swiss cheese”. Rigid appendages 1802B could also be coated with any suitably-sized texture (described further below) so long as the texture particle sizes were somewhat similar to or smaller than the diameter of the appendage. Rigid appendages 1802B could be made from acrylic, fiberglass, epoxy, polystyrene, polyester, ABS, polycarbonate, resin, or any other suitably stiff non-corrosive material or combinations thereof. For example, one rigid appendage embodiment is constructed of 3 mm diameter transparent polycarbonate of 20 mm length which is coated with a dusting of 0.5 mm grain size transparent acrylic particles which are bonded with a thin layer of translucent epoxy; finally, 0.5 mm diameter cross-drilled holes are placed through the appendages every 1 mm of the length. The appendages could instead have the holes and/or textures molded-in during the manufacturing process.

In some embodiments, appendages 1802 (whether rigid or resilient) may be made reflective (white or mirror) or translucent or transparent, so as to absorb as little illumination as possible and thus provide more illumination to the algae. A metallic reflection surface may be possible if coated with a transparent non-corrosive coating. And although the drawing depicts the appendages as being substantially cylindrical rods or needle-like protrusions, they can be any shape such as square, rectangular or triangular, or could be no defined shape at all such as the shape of a weed or tree branch. In such a case, the effective diameter of the appendage would be measured from its outer most portions.

FIG. 19 illustrates a perspective view of an embodiment of a non-linear upflow algae scrubber. Scrubber 1900 includes appendages 1902 and support member 1904. As with previous embodiments, all of appendages 1902 are discrete and not connected to one another, allowing a harvesting comb to pass with one motion from support member 1904 to the upper appendage ends. Appendages 1902 are attached to a support member 1904 (in this case a flat surface) which also contains gas ports 1906 to enable gas bubbles to traverse up the appendages 1902 while in contact with the appendages 1902. Illumination (not shown) from above, or from one or more sides, or from any combination of directions, enables photosynthetic macroalgal attachment and growth to occur on appendages 1902. Support member 1904 can be, in some embodiments, a bottom panel of any container of water, or it can be the bottom of a dedicated growth compartment which contains the growth, or the bottom of a wastewater treatment section. In still further embodiments, support member 1902 could also be the bottom of a natural water body such as a pond, which would require the gas bubble ports 1906 and associated gas supply apparatus to be either buried under or laid upon the sediment. The appendages 1902, depending on their diameter and material, could be attached to support member 1904 via any suitable method, e.g., glue, pass-through-holes and knots, non-corrosive hardware (plastic nuts and bolts), friction fit, pipe loop-around, weights, burial, or any combination thereof. Of particular importance in this embodiment is the determination of the average distance between appendage surfaces. Since this non-linear array of appendages 1902 does not have a fixed distance between appendage surfaces as might occur in a repeating-pattern grid, the determination of an average distance is used instead. Measurements can be taken of several (or all) of the distances between appendage surfaces, as measured at support member 1904, and the average can be found. Thus when “distance between appendage surfaces” is used to describe non-repeating appendage distances such as in FIG. 19, it is the “average distance between appendage surfaces” that is meant.

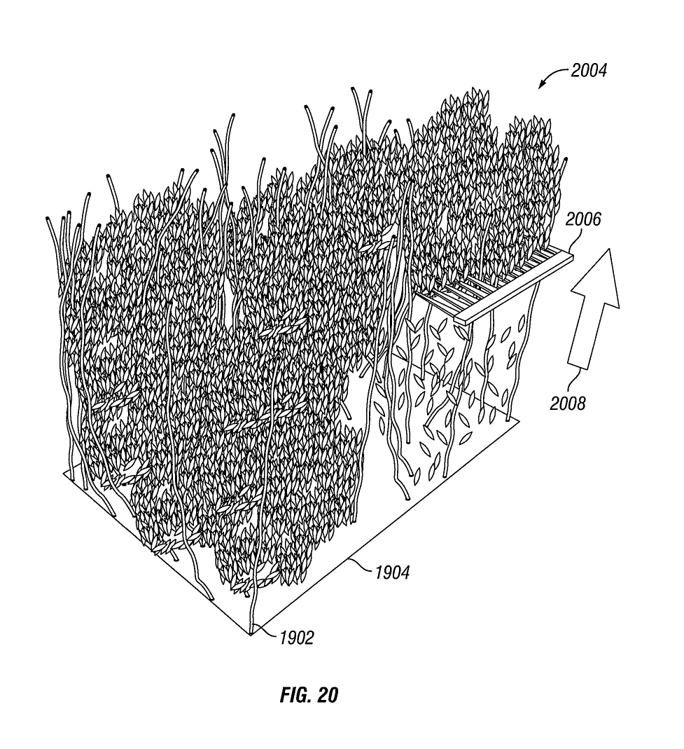

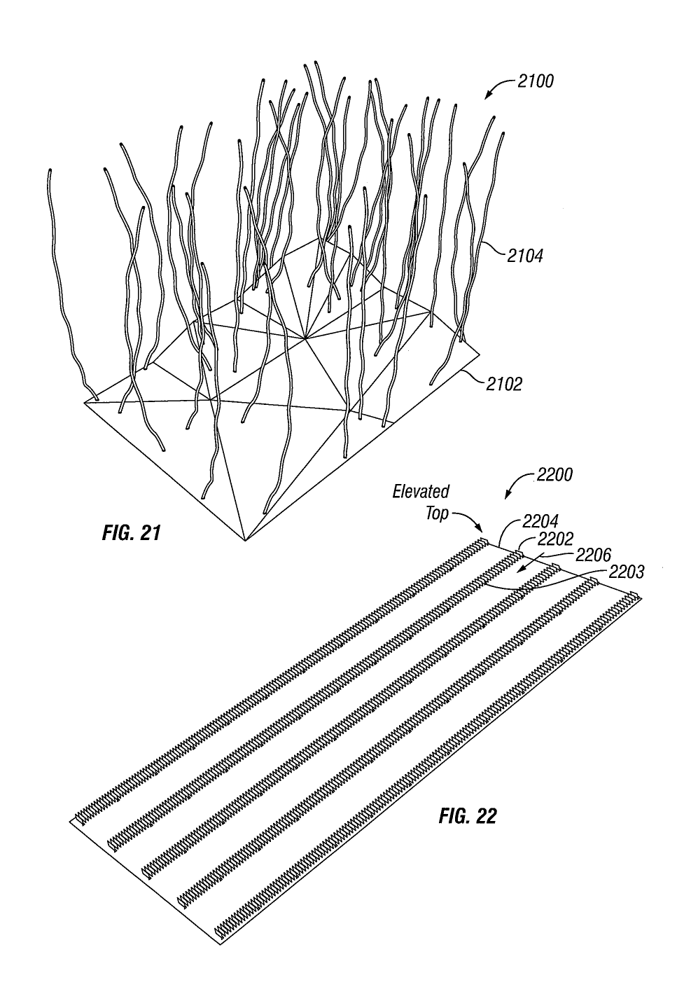

FIG. 20 shows the non-linear upflow algae scrubber of FIG. 19 having attached macroalgal growth and a harvesting comb. As in previous embodiments, the algal growth 2004 attaches to appendages 1902 and harvesting comb 2006 can be used to remove the algal growth 2004 in direction 2008.

FIG. 21 illustrates an embodiment of a non-linear upflow scrubber. Scrubber 2100 is similar to scrubber 1900 of FIG. 19 except with a variable support member 2102 for appendages 2104. By “variable” it is meant that support member 2102 has a non-planar surface. Such a variable support member 2102 might be encountered when the installation is an aquarium sump, or wastewater facility, or other installation where appendages 2104 must be placed on a variable surface or a on top of and around obstacles. A variable support member 2102 also allows for the possibility of growing different species of macroalgae with different depths and lengths of appendages 2104. Several embodiment variations of any of the above appendages will now be described.

A larger upflow embodiment envisioned for filtering large bodies of water such as pools, wastewater facilities, lakes or rivers, or for seaweed cultivation in oceans, uses larger and stronger appendages such as ropes. For example, one upflow embodiment uses ropes which are 12 mm in diameter, 600 mm long, and spaced approximately 150 mm apart. Such spacing is required to minimize entanglement while still allowing for upward comb harvesting; however, there will probably be un-grown space between the appendages. The ropes may be anchored directly to a gas supply hose, at a location on the hose between the gas bubble ports, although in another embodiment they are attached to a separate structure adjacent to the gas bubble hose. The entire structure and ropes are held in position just below the water surface, although in another embodiment it could be placed lower so that boats, people, etc. could pass over it without disturbance. A waterfall version of this larger embodiment is envisioned using the same dimensions but less distance (75 mm) between appendages; the greater force of gravity compared to the force of upflowing bubbles keeps the waterfall appendages from getting tangled as easily.

Another embodiment for upflows, but in a reversed configuration, is shown in FIG. 11; it couples a weight to the bottom of each appendage instead of permanently anchoring them, and secures the tops of the appendages to a stationary object. The weights keep the appendages extended down into the water against the upflowing bubbles, but when the stationary object is lifted out of the water the appendages will be hanging vertically from it much like swings hanging from a tree, ready for harvesting in one continuous downward motion. This may be useful for wastewater applications when attachment to the benthic substrate is not be desired; the entire unit is kept from touching the bottom, and can be lifted out of the water for harvesting instead of requiring entry into the water for harvesting.

In still another embodiment, for both upflows and waterfalls, a luminous appendage can be used. By providing illumination that is emitted from the appendage, the algal “roots” which attach to the appendage will survive longer as the growth becomes thick. The illumination would best be emitted along the length of the appendage (emitted radially, commonly known as “side emitting”), so as to reach all the roots that were attached to the appendage. Such luminous appendages might be constructed of fiber optic cables (possibly with an illumination projector coupled to their ends), or light emitting diode (LED) ropes with the LEDs internal to the ropes. For outdoor applications, a solar collector could be utilized to provide funneled illumination to narrow appendages.

FIG. 22 illustrates a perspective view of another embodiment of a scrubber. Scrubber 2200 includes appendages 2202 attached along support member 2204. Appendages 2202 may be, for example, ropes, ribbons or strings could be used to enhance support member 2204. In some embodiments, support member 2204 may have a planar surface for attachment of appendages 2202. Each of appendages 2202 may be anchored at one end to support member 2204, while the other end of each of appendages 2202 moves freely with the water current. Due to the sloped orientation of support member 2204, water may flow in a lengthwise direction as illustrated by arrow 2206 along support member 2204 and along the growth surface 2203 of each of appendages 2202. Such a configuration would greatly increase the Illumination Ratio of the embodiment as a whole, because of the higher Illumination Ratios of appendages 2202 compared to support member 2204 by itself. The appendages 2202 would take up very little additional space compared to support member 2204 because appendages 2202 would “fold” with the water flow and thus lie parallel to the planar surface of support member 2204. This embodiment could operate in both vertical waterfalls and upflows, but a horizontal (river) sloped support member 2204 (e.g., the top end of support member 2204 elevated as shown in FIG. 22), would especially be enhanced by the addition of appendages 2202 to its upper surfaces (the side which is illuminated), because not only would the appendages increase the Illumination Ratio of the algae scrubber as a whole, but they would also help guide water over thick algae “islands” which are troublesome in horizontal river embodiments (the algal clumps grow up and block water flow). In this case, the larger the diameter of the appendages, the more the appendages would function as a “rail” and the better the water flow would thus be guided over the island clumps. This is detailed further below.

In still further embodiments, algal growth may occur within a growth compartment with rough prickly appendages so as to purposely grow macroalgae on everything. With water, illumination, and gas bubbles added to the insides of the compartment, it has been found that algal growth attaches to the rough appendage textures. In addition, it is recognized that by completely eliminating any smooth surface in the growth compartment, there would be no place for algal growth to “try” to attach to, only to let go and float away later because of lack of surface roughness.

Attempting to grow algae “all over everything” is against the design criteria for prior art algae scrubbers because the entire purpose of a scrubber is to grow algae in a place that is separate from an aquarium so that the algae can be harvested easily and taken out of the system without having to scrape algae off of aquarium rocks, etc. In order to do this, removable parts were designed into the prior art scrubbers, such as detachable waterfall delivery pipes, removable screens, detachable lights, etc., so that the parts that grow the algae can be removed and harvested without having to remove and clean the entire scrubber (some prior art waterfall scrubbers are very bulky). Indeed, sometimes the growth does eventually get “all over everything” and in these cases the entire unit needs to be removed, taken apart, and cleaned. Since waterfall units are elevated and connected to a water supply and drain pipes, disassembly is not a welcome task and thus is often neglected; a user would not want to speed up the process of needing to clean everything. However, an embodiment with texture appendages (with or without rope, ribbon or string appendages) and an open or removable top such as described below, allows for the simple reaching-in and harvesting of the growth without needing to remove any attachment materials, and further, the growth is by design meant to “get all over everything” so as to turn all surfaces into biomass production surfaces which will not let go of the growth. And because the growth compartment is submerged with rapidly upward flowing gas bubbles, any flowing debris (loose algae or livestock, etc.) will resist “catching” and getting stuck on the appendages because the debris is carried over the appendages by the gas bubbles.

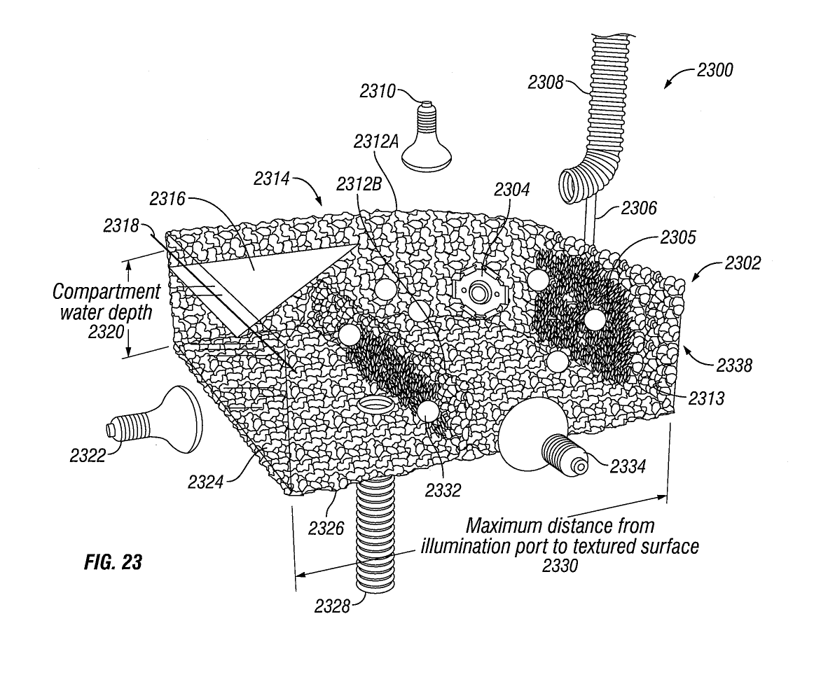

FIG. 23 illustrates a perspective view of one embodiment of a scrubber. Scrubber 2300 includes a growth compartment 2302 with prickly or rough texture appendages which have been applied to all the non-illumination-port inner surfaces. (“Texture appendage surface” and “textured surface” will be used interchangeably herein). In some embodiments, scrubber 2300 includes growth compartment 2302, which could be where upflow algae scrubber rod, rope, ribbon or string appendages and/or planar attachment surfaces (not shown) are disposed, or it could be the drain area where a waterfall algae scrubber drains down into from overhead, thus creating upflowing gas bubbles as disclosed in co-pending international application PCT/US2012/031714. Alternatively, growth compartment 2302 could just be a dedicated compartment with no other macroalgal attachment means at all, just textured inner surfaces 2338 and illumination ports 2324. In some embodiments, the illumination port 2324 forms a transparent wall of growth compartment 2302. In some embodiments, there may not be any illumination ports at all; illumination would be provided from above the water surface. In any case, the texture appendages 2313 are conforming to the inner surfaces 2338 of growth compartment 2302 in a sealed manner (no gap between the texture appendages and the inner surface) and serve as macroalgal attachment points for macroalgae 2305 to attach to and grow on the walls 2312A, bottoms 2326, and dividers 2312B within the compartment, thus making use of the exposed inner surfaces of the compartment 2302 instead of having non-textured (e.g., “smooth”) surfaces inside the compartment which will only attempt to let algae attach but then will release the algae they are larger, causing loss of filtering or cultivation. In addition, growth compartment 2302 may include a top member 2316 which is submerged under the water and encloses a portion of the top of growth compartment 2302. Top member 2316 may be textured to facilitate algal growth.

When growth compartment 2302 is wide and shallow such as in FIG. 23, the gas bubble turbulence within the compartment will cause the upflowing gas bubbles 2332 to contact all parts of the compartment 2302, including the bottom 2326, if the compartment water depth 2320 inside the compartment 2302 is less than approximately 60 mm. The gas bubbles 2332 will contact the bottom surfaces 2326 more if the compartment water depth is less than approximately 40 mm, and will contact the bottom surfaces even more if the compartment water depth is less than approximately 20 mm.

Growth compartment 2302 contains inner surfaces 2338, of which at least one is a texture appendage surface. A bubbling mechanism 2328 or 2308 is also included. In some embodiments, bubbling mechanism 2328 or 2308 may be a hose, which is aligned with growth compartment 2302 so that at least a portion of gas bubbles produced by bubbling mechanism 2328 or 2308 are directed to travel along, and in contact with, inner surface 2338. Representatively, bubbling mechanism 2308 may be supported over growth compartment 2302 such that it directs bubbles down into growth compartment 2302 while bubbling mechanism 2328 is inserted through a hole within growth compartment 2302 such that it directs bubbles up and into growth compartment 2302. One or more of illumination ports 2324, open ports, elevated ports 2314, and dividers 2312B may also be present. The size of the growth compartment 2302 should be enough to allow substantial quantities and thickness of macroalgae 2305 to attach and grow on the texture appendage surfaces, for example textured divider 2312B, textured inner surface 2338 or textured bottom surface 2326, and also on any rod, rope, ribbon or string appendages as well as any prior art planar attachment surfaces within the internal area of the compartment. In a compartment with only textured surfaces and no other attachment materials, it is preferred that each textured surface be given at least 20 mm of open space so that the attached macroalgae can attain a thickness of 20 mm. This distance 2330 may be from a textured inner surface 2338 to an illumination port 2324, or from a textured surface to the water surface. For example, in some embodiments, a maximum distance from the illumination port to the textured surface may be about 300 mm or less, or about 100 mm or less, or about 40 mm or less, or about 20 mm or less. If the growth compartment contains other attachment surfaces such as rod, rope, ribbon or string appendages, or prior art planar attachment screens, then the compartment can be widened to accommodate them. Illumination members 2322, 2334, 2310, and/or 2304 (a submerged LED) may further be provided along one or more of the sides or top of growth compartment 2302.

“Inner surfaces” are the surfaces of the growth compartment walls which contact the water inside compartment and prevent this water from traveling to the outside of the compartment when the internal growth compartment water level is at operating level. (The internal water may, however, travel to the outside of the compartment via a port elsewhere). By contrast, “dividers” are walls which are internal to the growth compartment and have internal water on both sides of the divider, e.g., a divider does not contact water external to the compartment, and does not prevent water internal to the compartment from traveling to the outside of the compartment. Dividers may be smooth or textured.

“Texture appendage surfaces” are inner surfaces of the growth compartment walls that have been covered with, or are made with, small appendages which protrude from the walls into the interior compartment of the growth compartment. Textured surfaces can be above or submerged below the operating level of the interior water surface of the compartment, so as to accommodate fluctuating water levels or to provide attachment for macroalgae which is growing up and out of the water.

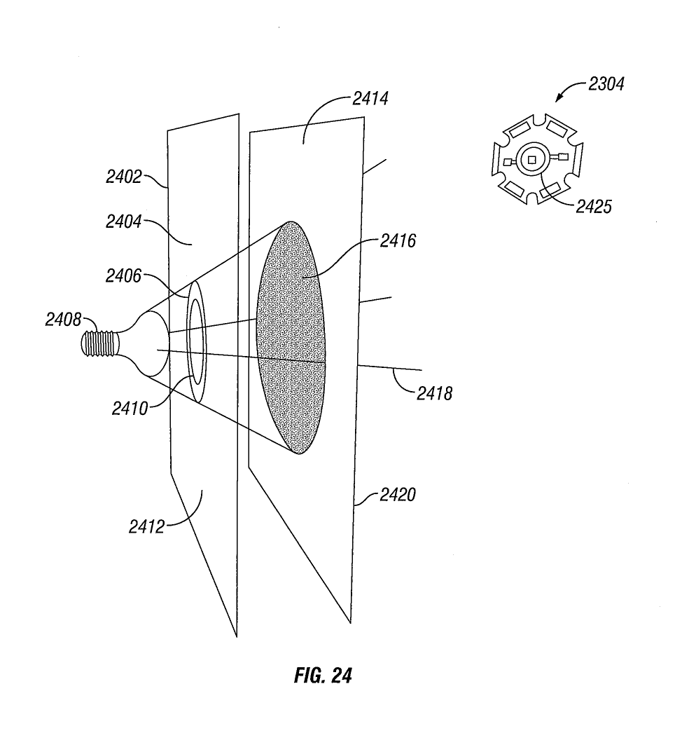

FIG. 24 illustrates a perspective view of one embodiment of an illumination port as defined in the present application, and in the growth compartment of FIG. 23. “Illumination ports” are the non-textured submerged portions of growth compartment wall 2402 which are translucent or transparent and have an illumination member 2408 shining through them so as to illuminate at least one textured inner surface 2414 inside the growth compartment with enough illumination to grow substantial attached macroalgae 2416 on the textured surface 2414. Illumination ports may also be an optical lens 2425 of a submerged illumination source, such as the LED illumination source 2304, previously illustrated in FIG. 23, and also illustrated in FIG. 24. If, for example, a translucent or transparent surface such as surface 2402 or optical lens 2425, which is separate from growth compartment wall 2420, does not have sufficient illumination shining through it to grow substantial macroalgae on at least one textured surface, it is not an illumination port. Thus, a large translucent or transparent surface with only a small illumination source shining through a section of it is only an illumination port directly in front of the illumination source, areas 2406 and 2410, not area 2404 outside of the illumination zone 2418. An illumination port can be part of the growth compartment (where the illumination means is shining in), or it can be inside the growth compartment (such as optical lens 2425 of illumination means 2304 inside growth compartment 2302), or it could be adjacent to and in optical communication with the growth compartment. An example of an adjacent illumination port would be a hang-on-glass algae scrubber embodiment wherein the growth compartment is coupled to a translucent or transparent aquarium wall or sump wall such that illumination external to the aquarium wall or sump wall can enter the growth compartment through the glass.

Users generally want more nutrient removal and more cultivation, and generally avoid modifications which reduce either; because photosynthesis is generally proportional to illumination, users usually try to increase illumination and/or try to minimize photoinibition (photoinibition is when the illumination is so strong it prevents photosynthesis). However, because growth compartments are submerged (their illumination sources can be submerged also), it can actually be more productive to have smaller illumination ports, and especially, illumination ports with photoinibition. Illumination ports are defined herein as enabling two different levels of illumination: “photoinhibiting” and “non-photoinhibiting”. A photoinhibiting illumination port, represented by area 2410, enables enough illumination through the port to substantially prevent macroalgae from attaching to and growing on the illumination port itself during the normal harvesting periods of growth compartment operation. In other words, in the time frame between normal harvests of the growth compartment (typically 7 to 21 days), a photoinhibiting illumination port (area 2410) will stay substantially free of attached macroalgae. A non-photoinhibiting illumination port, represented by area 2406, however, enables lower illumination intensity than a photoinhibiting port does, and thus may accumulate attached macroalgal growth on the illumination port itself during the normal harvesting period. Both photoinhibiting and non-photoinhibiting illumination ports provide illumination to texture appendage surfaces 2414 inside of the growth compartment, but a non-photoinhibiting port may substantially reduce in intensity over time due to macroalgal growth on the illumination port itself. By reducing the illumination port area compared to the textured surface area (provided enough illumination emits from the illumination ports to substantially grow attached macroalgae on the textured surfaces), the size of the growth compartment can be minimized and the illumination ports will be substantially photoinhibiting because all the illumination will be condensed into the smaller illumination port size. For example, in some embodiments, the total area of all illumination ports is less than 10 percent, or less than 1 percent, or less than 0.1 percent, of a total area of all submerged textured surfaces.

If enough illumination does not pass through a particular section of a translucent or transparent surface, for example section 2404, to enable substantial macroalgal growth on a textured inner surface of the growth compartment, then that section of the translucent or transparent surface is not an illumination port and is instead an undesirable smooth surface which will allow macroalgae to attach, and let go. It should be noted, however, that a thin “dusting” of “green powder looking” micro-algal growth which does develop on an illumination port is normal, and can be brushed away during harvesting. This thin (usually less than 0.5 mm thick) powder-looking green growth is not a hair macroalgae species as described earlier in this application, and thus will block minimal illumination compared to the thick hair macroalgae that is preferred to attach and grow on the texture appendage surfaces. Thus, the majority of a submerged translucent or transparent surface 2402 should be concentrated with illumination sources 2408 instead of just a few sources 2408 across a large section of a translucent or transparent surface 2402 (FIG. 24, for illustration purposes, depicts only one illumination source 2408 external to the submerged translucent or transparent surface 2402, however there could be enough illumination sources 2408 to “fill” this submerged translucent or transparent surface 2402 with strong illumination from one end to another).

Returning now to FIG. 23: “Open ports” are submerged portions of the compartment, including the top if submerged, which have no wall and thus have open fluid and optical communication with water on the outside of the compartment. Allowing illumination to escape out of the growth compartment through an open port can cause undesirable nuisance algae growth in the aquarium or sump, and in addition, the illumination may appear very unnatural (especially if pink plant-grow bulbs, or 660 nm red LEDs are used), as well as being out-of-sync with daytime/nighttime aquarium illumination photoperiods. Open ports can be with or without an illumination source shining into the compartment through the open port. Livestock may also enter open ports undesirably, and recirculating dwell-time of water inside the compartment becomes difficult or impossible to control when there is little physical separation between the water internal and external to the compartment.

“Elevated ports” are above the compartment's internal water surface (see port 2314 in FIG. 23). These ports may, however, be below the external water surface (water on the outside of the compartment). If below the external water surface level, elevated ports can stay above the internal water surface by creating a higher gas pressure inside the compartment which will push the internal water surface lower. Elevated ports may or may not have illumination shining down into the water from above, and they may or may not have airflow flowing through them. In other words, although they are a “port” they may still be sealed.

In some embodiments, the bubbling mechanism associated with the growth compartment can be as simple as (as stated above) water that drains down into the growth compartment from a water conduit above the compartment's internal water surface; such downward flowing water, when it hits the compartment's internal water surface, will produce gas bubbles within the compartment that flow upwards. The higher the velocity of the downward flowing water, the more gas bubbles are created. Such an overhead water conduit could be coupled to the side walls of the growth compartment, or a bracket could be placed across the growth compartment to which the water conduit could be coupled. A venturi could also be included within the water conduit so as to add gas bubbles, or diffractors could be placed at the outlet of the water conduit either above or below the internal water level of the growth compartment. Such a configuration is illustrated in co-pending international application PCT/US2012/031714, which is incorporated herein by reference. In still further embodiments, the bubbling mechanism may be a hose which outputs gas into the water as illustrated by bubbling mechanisms 2308 and 2328 of FIG. 23. Other bubbling mechanisms are also contemplated, for example, airstones, woodstones, bubble ports, bubble plates, airlifts below the compartment, etc.

There should be substantially no non-textured surfaces in the submerged portion of the growth compartment except for illumination ports, when the compartment's internal water level is at operating level; in other words, any non-textured internal surface which is not meant for algal attachment should be transparent or translucent with illumination passing through it from an illumination source on the opposite side, and said illumination should be of sufficient strength to substantially grow attached macroalgae on an inner textured surface, and preferably, strong enough to photoinhibit macroalgal growth on the illumination port itself. This applies to external illumination sources on the outside of the growth compartment which illuminate a textured surface through a translucent or transparent compartment wall, or internal submerged illumination sources (inside the compartment) which have translucent or transparent lenses or covers. By requiring the surfaces inside the growth compartment to be either illumination-enabling or algal-attachment-enabling, substantially no non-textured (“smooth”) surfaces will be available for algae to try to attach to, only to let go and float away later when the algae are larger.

“Substantially all submerged surfaces shall be textured surfaces or illumination ports” is defined to mean that any non-textured surface or non-illumination port in growth compartment 2302 below the internal water surface operating level 2318 should be small enough such that any algal growth which attaches to and subsequently detaches shall not be in a quantity to reasonably diminish the overall filtering or cultivating capacity of the growth compartment. Preferably, there would be no such submerged non-textured, non-illumination-port surfaces. However, items such as screws, illumination housings or mounts, welded joints, gas tubings, etc. may be permissible if it is not feasible to cover them with texture appendages. 50 percent would be a preferred maximum of non-textured, non-illumination-port submerged surface area, compared to the total submerged surface area; 20 percent would be more preferred; 5 percent even more preferred, and 0 percent most preferred.

“Substantially no open ports” is defined to mean that the amount of non-walled submerged area of the growth compartment, for example growth compartment 2302, in fluid and optical communication with the water external to the compartment when the compartment's internal water level is at operating level, is less than 50 percent of what would be the total inner submerged surface area if the open ports were walled; 20 percent would be more preferred; 5 percent even more preferred, and 0 percent most preferred.

The technique of utilizing substantially all of the internal growth compartment surfaces for attached growth can greatly increase the filtering or biomass production capacity of an algae scrubber or seaweed cultivator of a given size; if these surfaces are not textured and utilized for algae attachment and growth, they will likely be covered in growth anyways but the growth will detach and float away because there is nothing rough and/or porous for the algae to grab on to when the algae are larger. The basic concept of strong algal filtering or cultivation is that substantially every surface which is illuminated by the illumination means should be utilized for the desired growth if not being utilized for illumination.

The attachment texture appendages 2313 might be applied by coating the growth compartment inner surfaces 2338 with a mixture of protrusions and binder; the mixture would flow as a thick liquid or paste and would solidify with many of the protrusions extended outwards from the binder. Or the binder might be applied first, then the protrusions added to the binder, so that the binder solidifies with the protrusions extended outwards from the binder. If the compartment, for example compartment 2302, were made of fiberglass cloth and resin, the fiberglass cloth might be roughed up initially so as to have broken strands protruding out of the cloth (strength would not be a concern). The resin would then be added while still allowing the broken strands to protrude, thus allowing the strands to become the protrusions of the attachment texture. The attachment texture appendages 2313 could also be formed by stamping or roughing up the compartment walls, for example walls 2312A, 2312B, 2326, especially if the compartment were made of a material like plastic that could be molded when heated. When heated, many small ridges or spikes could be stamped or roughed into the plastic material. Or the attachment texture appendages 2313 could be applied as a layer of synthetic cloth or screen onto a base of glue or binder, much like sheets applied to a bed, as long as no gap remained between the screen and the compartment wall. The compartment walls could even be made exclusively of texture particles in a binding resin; once formed into a solid shape the particles would effectively form the walls of the container.

The texture 2313 might be needle-like, non-metal protrusions which might be plastic-welded into the compartment walls, or glued to the walls, or the protrusions might be formed by partially melting the compartment surface and “planting” or “sticking” the needles into it. Needle-like protrusions could also be made by starting with a surface pre-drilled with holes, then passing some thin monofilament line (such as fishing line) back and forth through the holes, then gluing the holes and cutting the filament to the desired lengths. In still further embodiments, texture 2313 might also be gravel-like protrusions, in which case gravel or sand particles could be glued or pressed into the compartment surfaces. Or the texture 2313 could be mortar-like, and could be applied the way wet stucco is applied to a wall. Other paste-like hardening texture materials might be automotive body repair filler (e.g., “Bondo”), waterproof plaster, or ceramic granule paste. Waterproof sandpaper could also be glued to the surface. Translucent or transparent glass/quartz particles, glued with a transparent or translucent glue, would provide a somewhat translucent texture, as would a transparent or translucent epoxy that was roughened just before curing; these would work well if they were attached to a white (reflective) surface. Lastly, a very available option for aquarium owners might be aquarium safe white silicone (such as GE-I) with 2-3 mm white crushed-coral gravel particles pressed in.

These techniques have in common that there is no open or empty space behind the texture particles for algae to try to attach and grow; rather, the compartment wall and the texture appendages are unified. Alternatively, in some embodiments, a planar attachment screen may be attached to a compartment inner surface in a parallel fashion, e.g., applying the screen onto the compartment inner surface much like sheets onto a bed, but using discrete mounting points whereby there is substantially no gap between the attachment screen and the compartment inner surface.

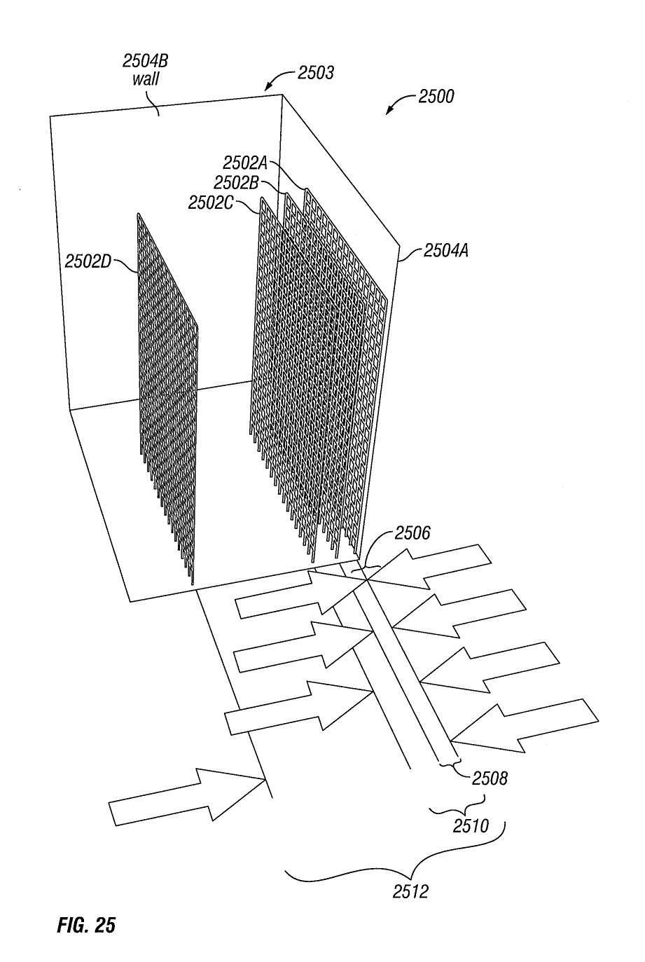

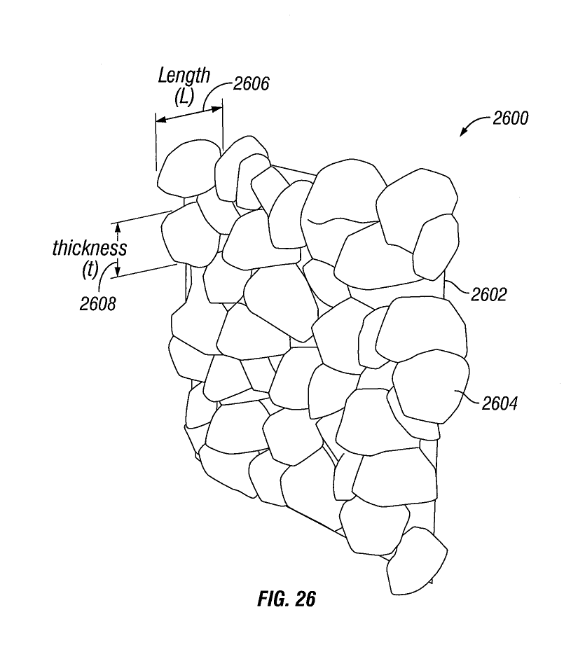

FIG. 25 illustrates a perspective view of one embodiment of a section of a growth compartment with planar surfaces as the attachment appendages. Representatively, in this embodiment, scrubber 2500 includes appendages 2502A, 2502B, 2502C and 2502D positioned within growth compartment 2503. Although only adjacent walls 2504A and 2504B of growth compartment 2503 are shown, it is to be understood that growth compartment 2503 may include additional walls. Each of appendages 2502A-2502D may be planar appendages in the form of screens. Appendage 2502A is shown positioned parallel to wall 2504A and, in some cases, appendage 2502A is laid flat on growth compartment wall 2504A and has a slight gap 2506 or substantially no gap between appendage 2502A and wall 2504A. In some cases, appendage 2502A may be rigidly attached to the growth compartment wall 2504A (with pins, hooks, etc.). While algal growth will attach to appendage 2502A, the slight open gap area between appendage 2502A and growth compartment wall 2504A, even if it appears to have substantially no gap, will allow growth to accumulate and this accumulation will be in very low illumination and water flow once appendage 2502A fills in with growth. Further, it will be very difficult to harvest the trapped growth between appendage 2502A and growth compartment wall 2504A unless appendage 2502A is removed. One way to avoid these pitfalls is to fuse appendage 2502A permanently to growth compartment wall 2504A such that there is no open area between appendage 2502A and growth compartment wall 2504A. Appendage 2502B, unlike appendage 2502A, does not touch growth compartment wall 2504A at any point. However its very near distance 2508 of approximately 8 mm to growth compartment wall 2504A does not allow sufficient illumination or water flow to reach between appendage 2502B and growth compartment wall 2504A, and will thus in effect also have a “dead zone” of growth accumulating as appendage 2502A does. If appendage 2502B is rigid, it will also be very difficult to harvest or clean with the limited 8 mm planar gap. Appendage 2502C, however, is placed at a minimum 20 mm distance 2510 from growth compartment wall 2504A. While exact recommendations would depend on the size of the appendage and the growth compartment wall, 20 mm should give enough room for illumination and water flow and harvesting between appendage 2502C and growth compartment wall 2504A. Appendage 2502D is placed well away from growth compartment wall 2504A as illustrated by distance 2512 to function as an independent surface.

The color of the protrusions/textures would be preferably white, or translucent or transparent with a mirror or white backing, so as to enable more illumination to bounce around inside the compartment and thus keep the algae and algal roots illuminated.

In some embodiments, in the case where the appendages are protrusions, the protrusion lengths might be 0.1 to 20 mm long, or for example, from about 2 mm to about 10 mm, or from about 4 mm to about 8 mm, extending out of the compartment wall, and might be angled in random directions or in similar directions. The protrusion thickness could be as thin as 0.1 mm each, or as thick as 5.0 mm each, or for example, from about 0.2 mm to about 4 mm, or from about 0.2 mm to about 3 mm, or from about 0.3 mm to about 3 mm, or from about 0.4 mm to about 2 mm, or from about 0.5 mm to about 1.5 mm. The protrusion spacing might be from about 0.2 mm to about 10.0 mm from appendage surface to appendage surface, in either a random or grid fashion. The protrusions would need to be secured so that they did not become dislodged when being scraped during harvesting. The protrusions could be rigid like grains of sand or gravel, or resilient like rubber particles. Protrusions with the smallest dimensions would generally be the cements, pastes, putties, sands or fine sandpapers; protrusions with mid-size dimensions would generally be the gravels, abraded synthetic fabrics, and molded textures; protrusions with the largest dimensions would generally be the large gravels, brush bristles, and secured rods.

FIG. 26 illustrates a magnified perspective view of a section 2600 of a texture appendage surface of a growth compartment. In this embodiment, the appendages which form a texture on growth compartment wall inner surface 2602 are particles or protrusions 2604. Protrusions 2604 are attached to growth compartment wall 2602 such that the protrusions 2604 extend into the growth compartment. Protrusions 2604 may be individual protrusions which are rough compared to compartment wall 2602, so as to provide a rough macroalgal attachment surface. The individual texture protrusions 2604 can be similar to, identical to, or different from each other in shape, size, composition, orientation and position. Protrusions 2604 may have a length 2606 and/or a thickness 2608 within any of the previously described appendage dimensions. For example, protrusions 2604 may have a thickness 2608 of from about 0.1 mm to about 5 mm, or from 0.2 mm to 4 mm, for example, from 0.3 mm to 3 mm, from 0.4 mm to 2 mm or from 0.5 mm to 1.5 mm. The protrusions 2604 ideally have a very rough surface (as felt with your hand), and jagged edges, so as to enable macroalgae to attach most effectively. In other embodiments, protrusions 2604 are a continuous sheet of “prickly” material, e.g., the “hook” side of hook-and-loop fastener material, or the abrasive tape that is applied to floors to prevent slipping. It should be understood that protrusions 2604 could also be needle-like protrusions, or rod-like appendages.

Growth compartments that are shallow, such as described herein (see, for example, FIG. 23), are very useful in compact applications such as the water surface of an aquarium that is under a hood (the user probably does not wish to see the filter), and in sumps below aquariums which are generally very crowded with equipment, especially when the entire scrubber floats. Making a growth compartment shallower, but wider, gives the same growth volume but restricts the growth to a thin upper surface area which is near to the illumination above it, thus minimizing self-shading. Further, harvesting becomes very simple: the user only has to reach in and pull the macroalgae out of the compartment. No macroalgal attachment materials need removal, and the user does not need to reach further down into the water as might be needed if the embodiment were one that sat on the bottom of the container of water. The user also has the option of just lifting the entire floating compartment out of the water. A floating compartment is often needed because of the variable water level of aquariums or sumps (or pools, lakes or rivers). Floating can be achieved by attaching closed cell foam or gas pockets to the growth compartment; alternately, the outside of the growth compartment could have inverted gas-trapping sections similar to an underwater diving bell, so as to trap gas and provide buoyancy. And when the growth comes right up to the compartment's internal water surface, another advantage occurs: the pathways that the gas bubbles make on the way to the surface provide optical “tunnels” for illumination to travel down through the growth. For example, the gas bubbles must make their way up through the algal growth, and these pathways (even if only momentarily) allow illumination to travel back down through that same growth which would otherwise block the illumination.

An enhancement to the water flow (and thus, nutrient flow) through an upflow embodiment can be achieved by placing an “airlift” below the compartment; the airlift can then also become the source of gas bubbles. The airlift can be a standard narrow vertical tube connected to the bottom of the growth compartment; gas is injected into the bottom of the airlift tube by an external gas pump, and the rising bubbles cause a rapid flow of gas and water to enter into the growth compartment. The bottom of the airlift tube may need weights to keep it in position.

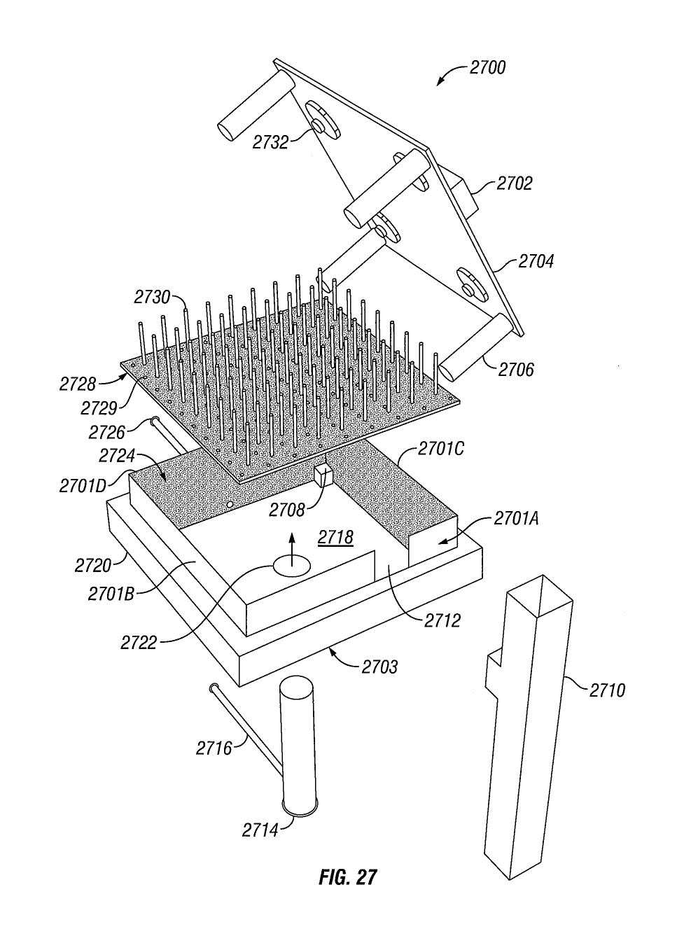

FIG. 27 illustrates an exploded perspective view of one embodiment of a scrubber which utilizes different types of appendages. Scrubber 2700 may be configured such that it is suitable for floating in an aquarium sump. In this aspect, growth compartment housing 2703 of scrubber 2700 floats on the water surface and is harvestable by lifting LED cover 2704 off without needing to turn off the LEDs 2732 or the gas bubble flow through ports 2729 within support member 2728. The growth compartment housing 2703 may include a plurality of side walls 2701A, 2701B, 2701C and 2701D extending from a base portion 2718 such that it is in the shape of a square box. In some embodiments, growth compartment housing 2703 forms a box having the dimensions of 12.5 cm wide by 12.5 cm long by 5 cm high. The inner surface of side walls 2701A-2701D may be coated with appendages textures 2724. In some embodiments, appendage textures 2724 are particle or protrusion type appendages formed by white acrylic adhesive paste (art paint). In still further embodiments, white quartz crystals of 1-2 mm size may be pressed into the paste and allowed to dry to form appendages 2724. Alternatively, instead of acrylic paste and quartz crystals, white mortar cement could have been used which provides both the adhesiveness and the roughness.

At the bottom of the inside of growth compartment housing 2703, a flat horizontal support member 2728 may be inserted such that it is suspended slightly above base portion 2718. Representatively, support member 2728 may sit 10 mm off base portion 2718 via 10 mm pedestals 2708. Support member 2728 may be a plate that is 2 mm thick plastic and is drilled to form a plurality of ports 2729 to allow gas bubbles from beneath support member 2728 to flow upwards through support member 2728. In this aspect, support member 2728 may function as a gas bubble plate. In some embodiments, support member 2728 includes 100 ports 2729 having a diameter of about 2 mm. Support member 2728 may further include appendages 2730 attached to and extending therefrom. Appendages 2730 may be different from appendages 2724. For example, appendages 2730 may be any of the previously discussed elongated appendages (e.g., strings, ribbons, ropes, etc.), while appendages 2724 may be in the shape of protrusions or particles. In some embodiments, appendages 2730 are attached to support member 2728 by drilling holes through support member 2728 and inserting and gluing appendages 2730 within the holes. In some embodiments, 100 holes of 1.2 mm diameter are drilled to allow insertion and gluing of 100 strands of 1.2 mm thick white woven polyester tennis racket string, each string extending up approximately 2.5 cm up from support member 2728 (about 3.5 cm from the bottom of compartment housing 2703). Support member 2728 may be set within compartment housing 2703 with no attaching hardware; it simply sits on pedestals 2708. In some embodiments, a hole (e.g., a 5 mm hole) is drilled through wall 2701D along a bottom portion, and a tube 2726 is inserted which supplies gas to beneath support member 2728 from an external gas pump, starting at about 10 lpm. A hole 2722 is further drilled in bottom portion 2718 (e.g., a center of bottom portion 2718) to allow water to be pulled in by the rising gas bubbles. In some embodiments, hole 2722 may be about 20 mm in diameter.

In some embodiments, cover 2704 may be an aluminum or carbon fiber lid with rods 2706 attached to the outer corners of cover 2704. In some embodiments, cover 2704 has a thickness of 1 mm. In some embodiments, rods 2706 may be carbon fiber (uni-directional) tubes or rods having a diameter of 10 mm. Rods 2706 may fit into the corners of compartment housing 2703, thus centering cover 2704 and also extending down into the water inside compartment housing 2703 and sitting on top of support member 2728. In this aspect, rods 2706 help to hold support member 2728 down and also keep cover 2704 at the height of the top of compartment housing 2703. In some embodiments, cover 2704 may have a weight 2702 attached to it to keep support member 2728 submerged in cases of high volumes of gas bubble flow. Coupled to the bottom side of cover 2704 are LEDs 2732. In some cases, LEDs 2732 are four 3-watt LEDs (total of 12 watts) of 660 nm (red) spectrum, which use a thermal adhesive to attach them to cover 2704. LEDs 2732 may face down towards support member 2728 and appendages 2730. Heat from LEDs 2732 may flow into cover 2704, through rods 2706, and into the water. The LEDs 2732 may operate for up to 18 hours per day, on a timer.

In some embodiments, scrubber 2700 may further include a flotation member 2720 to facilitate flotation of compartment housing 2703 on the external water surface. In some embodiments, flotation member 2720 may be on the outside of compartment housing 2703. Flotation member 2720 may be a closed cell foam, for example, a strip of 10 mm by 20 mm closed cell foam attached around the circumference of compartment housing 2703, at a height which causes approximately half (e.g., 2.5 cm) of compartment housing 2703 to float above the aquarium or sump water surface, and the remainder to stay below the water surface. During operation, gas flows 24 hours per day from an external gas pump into the space beneath the support member 2728. The gas flow may be adjusted by the user to provide rapid bubbling through ports 2729 in support member 2728 and between appendages 2730, but not too much so as to cause gas to start coming out of the water inlet 2722 on the bottom of compartment housing 2703. Once the gas has traversed the appendages 2730 and 2724, it then goes into the air space above the compartment's internal water surface and below cover 2704, and finally vents out of compartment housing 2703 via the overflow vent hole 2712. Vent hole 2712 may also be configured to let water out of compartment housing 2703. The LED illumination causes macroalgae to attach to and grow not only on the string appendages 2730 but also on the texture appendages 2724 on walls 2701A-2701D. After about 7 to 21 days of growth, cover 2704 can be lifted off and the user uses his fingers or a harvesting comb to reach into compartment housing 2703 and remove as much growth as possible without scraping it totally clean. During this harvesting, the gas can remain flowing if desired, or it can be turned off to prevent broken algae from flowing out of compartment housing 2703. The LEDs are then also brushed clean of any growth or other buildup due to splashing, and are then replaced back into position for more growth to occur. Any variation in water level in the sump will not affect the operation of scrubber 2700 because of the floating nature of growth compartment housing 2703. Lastly, if ports 2729 of support member 2728 become clogged, support member 2728 can be lifted out and brushed clean.

An optional higher flowing-version of scrubber 2700 can also be obtained by attaching airlift tube 2714 to hole 2722 in bottom portion 2718. Airlift tube 2714 may, in some embodiments, be a 20 mm diameter tube. Gas is then supplied to airlift tube 2714 via auxiliary tube 2716 instead of directly into compartment housing 2703 (i.e., any other gas holes in compartment housing 2703 are closed off and not used). The longer airlift tube 2714 is, the more airflow can be used, and the more water (and nutrients) will be delivered to the growing algae, however larger airflows may require a weight to be attached to the bottom of the airlift tube 2714 to keep it submerged vertically. Also optional on this embodiment is a bubble remover tube 2710, which can be made of a 20 mm square plastic tube attached to the overflow vent 2712 on the side of compartment housing 2703. As gas bubbles and water overflow out of compartment housing 2703 and into bubble remover tube 2710, the water travels downwards and escapes substantially bubble-free, while the gas escapes upwards into the atmosphere. Since bubble remover tube 2710 is on the side of compartment housing 2703, it will not interfere with removal of cover 2704 and harvesting.

Another type of appendage is the “rail” appendage as mentioned briefly in the appendage examples above. A rail appendage can be thought of as a rigid ribbon attached lengthwise to a planar support member. When algal growth gets very thick on a planar surface, the growth can cause a re-routing of the water flow to either side of the thick growth. This is because algae have an exponential growth phase; once they start growing they continue adding mass at that particular position until some other limitation slows their growth. With algae scrubbers, many times this limitation is water flow. Once a “clump” of exponential algae growth occurs in one position, water flow can no longer easily get to the “insides” of that clump, or “downstream” of that clump (which is “up” on an upflow planar surface, or “down” on a waterfall planar surface). This reduction of water flow into the clump reduces nutrient delivery to the clump (which is the very area that needs the most nutrients because it has the most algal mass), and also reduces nutrient delivery “downstream” of the clump.

In nature, when something large falls into a stream, the stream widens at that point to allow all the flow to continue around it without backing up. Many people have tried a similar concept for prior art planar waterfall algae scrubbers, by making the attachment surfaces wider; this does allow the “stream” to continue flowing around the obstacle, but ironically it does not increase filtering because the obstacles in this case (algal clumps) are the exact objects that needs water flowing through them (and not around them) in order to not die. If algae can't receive nutrients via water flow, then the algae can't filter the nutrients. So prior art planar surface effectiveness has been limited for several years by this situation; the larger the algae grew, the more the water would be routed around it, thus stunting the growth. This occurs especially in horizontal “river” sloped embodiments because the growth goes up into the air. The “rail” appendages disclosed herein, however, correct this situation by unexpectedly doing the exact opposite of traditional thought: reducing (instead of increasing) the cross-sectional area available for the water to flow through, thus forcing the water and nutrients into channels which go through the thick clumps instead of routing around them. Explained another way: using rails that are approximately perpendicular to the planar support member will help guide water flow in a straight path, again, so as to stop the water from routing around the algal clumps. These rails can work on upflow algae scrubbers, as well as vertical waterfalls, and also with horizontal river sloped scrubbers. Prior art has taught that narrow channels were not desired on horizontals. On smaller embodiments such as used on aquariums, however, algal clumps can create sizable blockages on wide surfaces because the algal clump remains the same size; narrowing the flow into channels by using rails helps direct water flow through these clumps.

Likewise, on upflows or vertical waterfalls, rail appendages operate by confining the upflowing water and bubbles or the falling water to a more narrow pathway which does not re-route as easily around algal island clumps, even though it may be hard to visualize because the clumps seem to stay submerged. However, even in the submerged areas there are fast flow areas and slow flow areas, and the idea is to keep all areas moving fast through the clumps so as to deliver the most nutrients to the clumps. Rails perform an additional function if they have a rough surface: They allow algae to attach and grow on the rail itself, so the algae can grow beyond the base layer of algal growth on the planar support member and proceed closer to the illumination and into more turbulent water flow. This helps the algae get out of the “overgrowth” that tends to block light and flow from reaching the algal roots on attachment support member surfaces (planar surfaces cannot “move about” as appendages can). This “growing beyond” the planar surface is especially useful if very dark or black algae is growing on the planar surface; dark algae normally blocks almost all light from reaching the roots, and it requires very strong light to cause lighter-colored algae to grow instead (stronger light generally grows lighter-colored greener algae). Rails enable the algae to grow towards the source of illumination (much like vines on a trellis), which if artificial light such as LED or fluorescent bulbs are used, can greatly increase in strength by being only a centimeter closer to the illumination source.

The material for a rail appendage may be any material that holds itself approximately perpendicular in relation to the main support member surface: open grids (porous), filled-in grids (non-porous), rough-up plastic canvas (knitting screen), solid plastic, etc. The material may be opaque, transparent, translucent, flexible, rigid, moldable or non-moldable. If a grid or screen is used, holes measuring about 2-4 mm have been found to attach the most algae per unit area. Rails, if made of cross-hatch plastic canvas, are relatively open (porous) to water flow until they fill-in with algae growth. However once they have filled-in with growth they are effectively a non-porous surface as it relates to directing water flow. Appendages per se, as described earlier in this application, could also be used for the rails if their diameter or width were large enough, and if they were attached along their length to the planar surface, and if their mass were enough to channel water flow as desired.

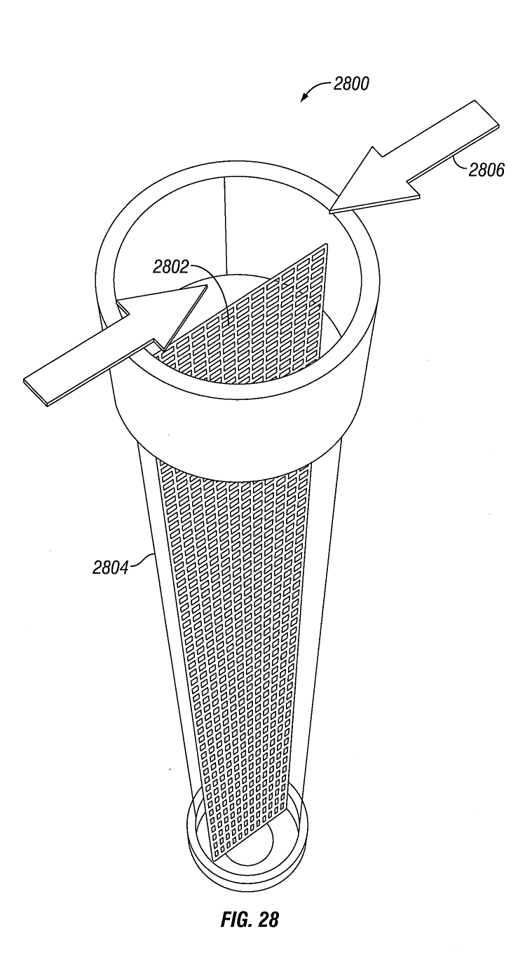

FIG. 28 illustrates a perspective view of the top of a tubular algae scrubber housing with a macroalgal attachment planar surface inside. Scrubber 2800 could be of an upflow or waterfall embodiment, and is useful in visualizing how water can be channeled through algal clumps. Not shown is the water, bubbles (if upflow), algal growth, or illumination which would be supplied from outside the housing, shining in. Scrubber 2800 includes a cylindrical growth compartment housing 2804 having a planar algal attachment surface 2802 positioned therein. Housing 2804 may be made of a transparent or translucent material such that illumination travels through housing 2804 to surface 2802. The distance between the arrows 2806 is the maximum cross-sectional growth distance. If this distance is kept below about 20 mm (i.e., the tubular housing 2804 has a diameter of 40 mm), then this would be sufficient to reduce re-routing of water flow around algal clumps, forcing most water flow through the clump as desired for efficient filtering and growth. If the maximum cross-sectional growth distance is larger than about 20 mm, then a growth clump may cause re-routing of water flow around it.

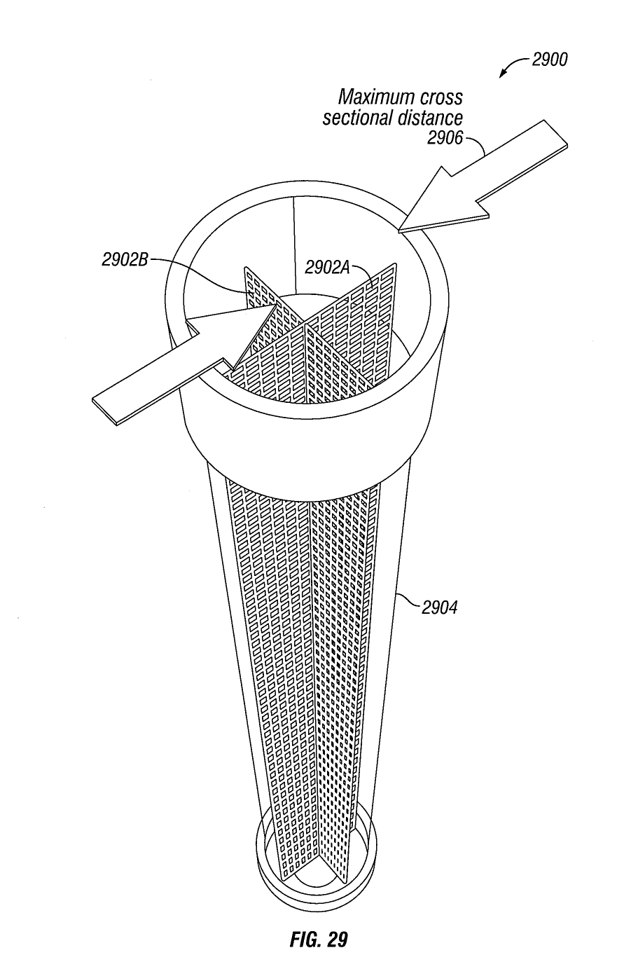

FIG. 29 illustrates a perspective view of one embodiment of a scrubber or seaweed cultivator. Scrubber 2900 may be substantially similar to that of FIG. 28 except that in this embodiment, a rail appendage water flow guide 2902B is attached perpendicularly to the planar attachment surface 2902A. If the maximum cross-sectional distance 2906 of housing 2904 is larger than about 40 mm, then the rail appendage water flow guide 2902B will divide this distance in half, thus restricting cross-sectional area to 20 mm and increasing the buildup of pressure to push water through algal clumps. In some embodiments, attachment surface 2902A and/or rail appendage water flow guide 2902B are made of a screen or grid type material such that they include openings or holes. Once algal growth fills-in the holes in the rail appendage water flow guide 2902B, the rail will act less-porous to the water; this will allow more pressure to build up in each cross-sectional area, thus “pushing” more water through any thick “clumps” of algal growth (non-porous attachment material could be used instead, so that filling-in with growth does not need to occur). FIG. 29, in particular, shows four separate water flow sections inside of the tubular housing; the four separate sections of attachment surface 2902A and rail appendage water flow guide 2902B, which form the water flow sections, could also be describe as “wings” emanating from a central point. It was contemplated using 5, 6 or more “wings” in a radial pattern so as to try to increase the algal attachment area even more, but the increased self-shading of one surface by another reduced the results too much. Not only do an increased number of wings reduce the illumination aperture between each wing, but the algal growth on one wing intercepts the algal growth on the adjacent wing near the central point and they grow over each other and cause further reduced illumination and growth.

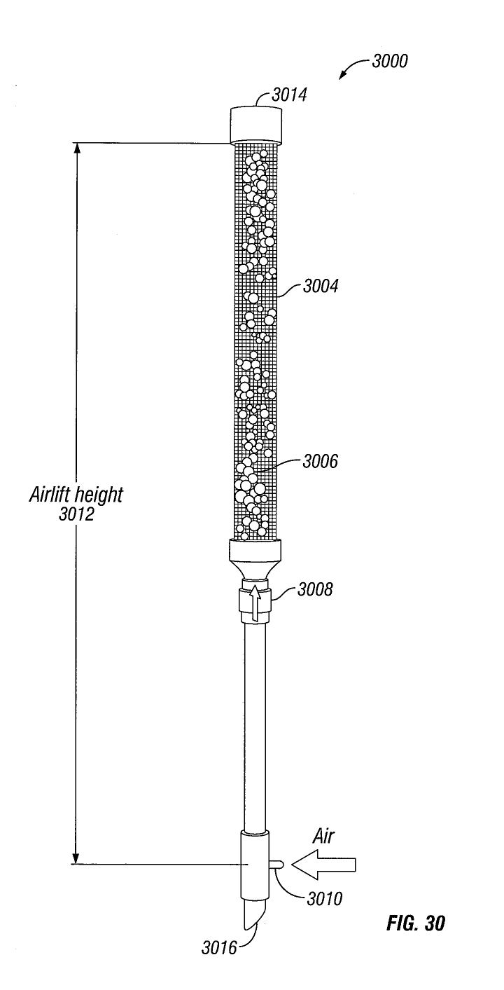

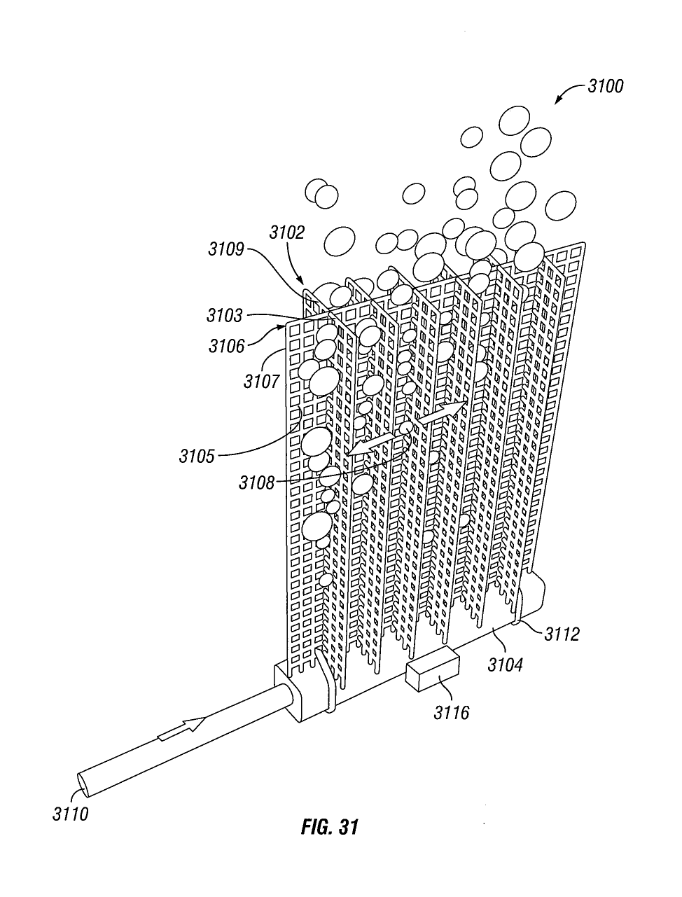

FIG. 30 illustrates a side view of one embodiment of an upflow scrubber with reduced cross section of flow area (via an added rail appendage, not visible) to further help visualizing. Scrubber 3000 includes housing 3004 having a water and gas outlet 3014 at one end and connected to a water and gas inlet tube 3016 at another end. In some embodiments, a valve 3008 may be positioned between housing 3004 and inlet tube 3016 in order to control water and/or gas flow through housing 3004. An air inlet port 3010 is provided at the bottom of water and gas inlet tube 3014. The distance 3012 from air inlet port 3010 to the top of housing 3004 is the “airlift height”. The pressure that the water and gas bubbles 3006 exert on algal clumps is proportional to the airlift height. If the cross-sectional flow area is kept small enough, this airlift pressure will be enough to force its way into and through the clumps, thus delivering nutrients to the clumps. If the cross-sectional flow area is too large, the airlift water/bubbles will instead re-route around the clumps, causing the clumps to not receive sufficient flow or nutrients inside them. Re-routing will also cause the macroalgal attachment material just beyond (above) a clump to receive reduced flow and nutrients. A waterfall embodiment of tubular housing 3004 functions similarly except the water pressure is based on the water column height above the algal clumps.

FIG. 31 illustrates a perspective view of one embodiment of an upflow scrubber. Scrubber 3100 includes a macroalgal attachment planar surface 3106 (in this case, a screen) attached to a gas bubbling mechanism 3104 (in this case, an airstone) and held down by a weight 3116. The macroalgal attachment planar surface 3106 may be attached to the gas bubbling mechanism 3104 by any suitable technique, for example tie wraps 3112, or bolts, brackets or the like. Gas bubbling mechanism 3104 may be attached to a gas supply tube 3110 which supplies a flow of gas to mechanism 3104. Shown protruding from both sides of the planar surface 3106 are the water flow guide rail appendages 3102, which extend out (in this case, on both sides) from the planar attachment surface 3106, thus dividing up the water/bubble flow area into several smaller cross-sectional areas; this keeps the water and bubble flow more in contact with the algae as the algae growth gets thick and tries to “re-route” the bubbles and water around it. The rails 3102 may be made of an open-grid screen material which fills-in with algae growth and becomes semi-porous to water. However, rails 3102 may also be made of a non-porous material, either opaque or transparent/translucent, which restrict the water and bubble flow at all times and thus do not require algal growth to fill in. The example single bubble 3108 in this drawing shows how the bubble cannot move left or right; it can only move up or out, thus limiting the bubble's ability to “get around” clumps. Rails 3102 are also incrementally closer to the illumination sources (not shown), which will enable the rails 3102 to get stronger illumination than the planar attachment surface 3106, especially when the planar surface is coated with very dark growth. Algal growth may occur along a front portion 3105 or a back portion 3107 of planar attachment surface 3106 such that it defines at least two macroalgal attachment surfaces. Flow guide rail appendages may further form a first water flow guide surface 3103, which is along front portion 3105 of planar attachment surface 3106 and a second water flow guide surface 3109, which is along back portion 3107 of planar attachment surface 3106.

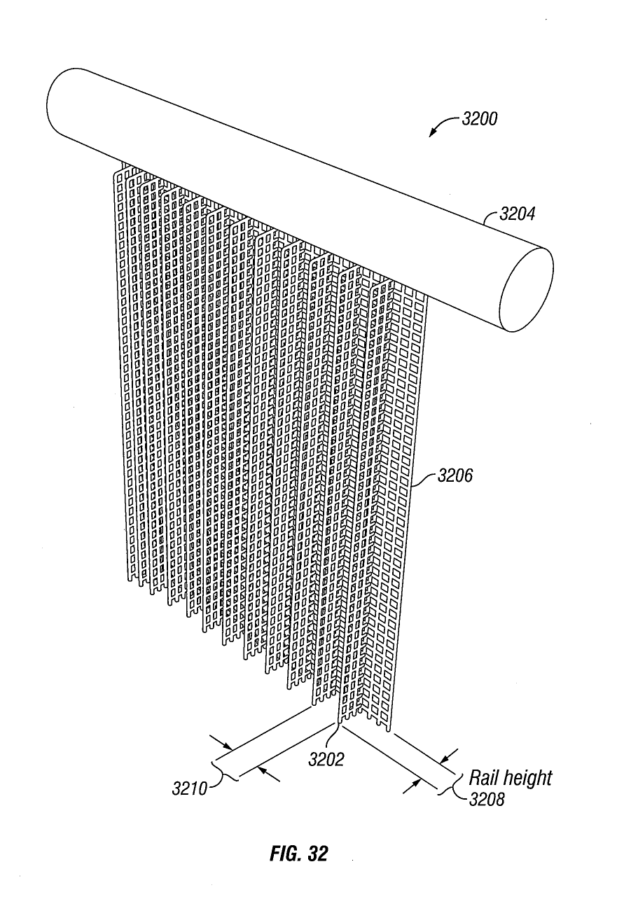

FIG. 32 illustrates a perspective view of one embodiment of a waterfall algae scrubber. Scrubber 3200 includes a support member 3204 (such as a water supply pipe) with rail appendages 3202 extending from a planar macroalgal attachment surface 3206 similar to that previously discussed in reference to FIG. 31. Support member 3204 includes ports that allow water to drain down over planar attachment surface 3206. This planar attachment surface 3206 has water flow guide rail appendages 3202 protruding out from it on just one side; the rails could just as easily protrude from both sides, however. The rails 3202 force water to flow straight through or straight over algal clumps while in contact with the clumps, instead of allowing the water to route laterally around the clumps as the water normally might try to do. The rails 3202 can be made of porous screen material which routes more effectively once filled-in by algal growth, however the rails 3202 could be non-porous, and could also be opaque or translucent/transparent. The rails 3202 also allow growth to get closer to the illumination means (not shown). Rails 3202 may further have a height 3208 and a distance 3210 between rails within any of the previously discussed dimensions. For example, a height 3208 of rails may be from about 100 mm to about 5 mm, for example, from about 75 mm to about 10 mm, or from 66 mm to 20 mm. A distance 3220 between rails may be, for example, less than about 100 mm, for example, less than about 60 mm, for example, less than 40 mm or less than 20 mm.

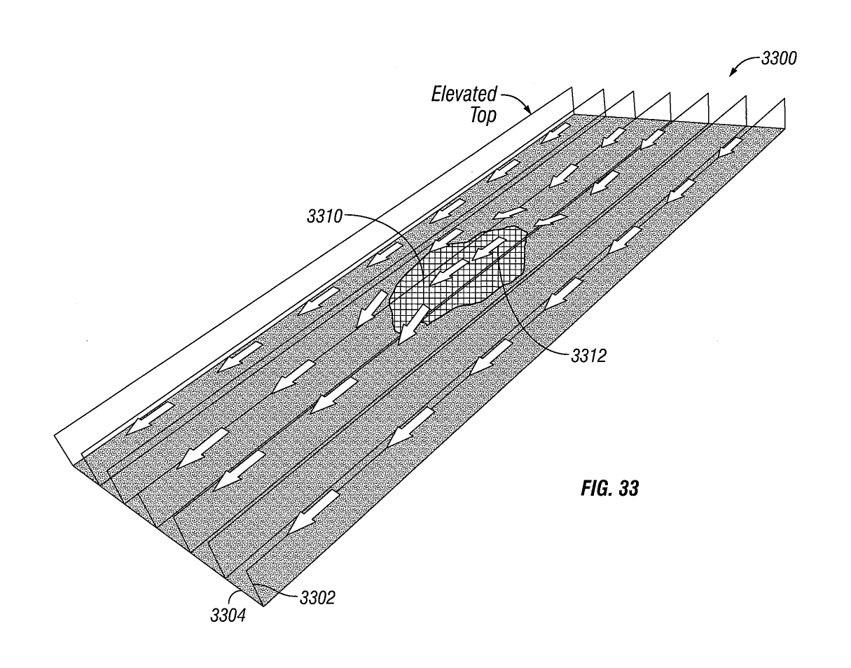

FIG. 33 illustrates a perspective view of one embodiment of a sloped waterfall scrubber. Scrubber 3300 may include a support member 3304 having rails 3302 extending therefrom. Rails 3302 may extend along an entire length dimension of support member 3304. Support member 3304 may be sloped such that water flows along support member 3304 and between rails 3302 in a direction of the arrows 3312. A thin algal growth is illustrated across the entire support member 3304, and a thick “algal island” clump of growth 3310 is illustrated in the middle which protrudes up above the thin layer. Algae islands such as this often occur on algal growth surfaces, whether the surfaces are horizontal, vertical waterfalls, or vertical upflows, however on horizontals the effect is the most pronounced because the clumps are actually pushed up into the air. The algal islands also tend to start out small, no matter how large the surface is, because the size of the individual strands of algae that make up the clump remains the same. Once the clump or island has started, it grows in size, blocking more and more water (and nutrients) from getting inside the clump and from getting beyond the clump. This causes the planar attachment area that is “beyond” or “downstream” of the clump to reduce or stop growth. It also creates difficulty for water flow, nutrients, and illumination to reach the insides of the clump itself which is the very area that has the most algae and therefore needs the most nutrients in order to continue filtration or cultivation.

Rails 3302 may be non-porous transparent rails. Here it can be seen how the rails 3302 keep the water flow in-line over and through the algae island (arrows are not visible inside the algae), instead of allowing the water to route laterally around the island. This same functionality, of using reduced cross-sections to keep the water flow from being re-routed around the algae island, occurs whether the algal growth surface is a sloped waterfall (as in the current embodiment), exact vertical waterfall (1 or 2 sided), horizontal waterfall (sloped river), or vertical upflow (1 or 2 sided), and occurs whether the rails are open (as in the current embodiment) or enclosed with a housing on all sides as in the tubular embodiment described above. Porous or semi-porous rails could also be used. It should be noted that slanted “river” type embodiments such as this do not have an option for upflowing gas bubbles beneath the support member 3304 as currently described, because the support member 3304 will quickly become blocked with macroalgal growth and thus block the gas bubbles.

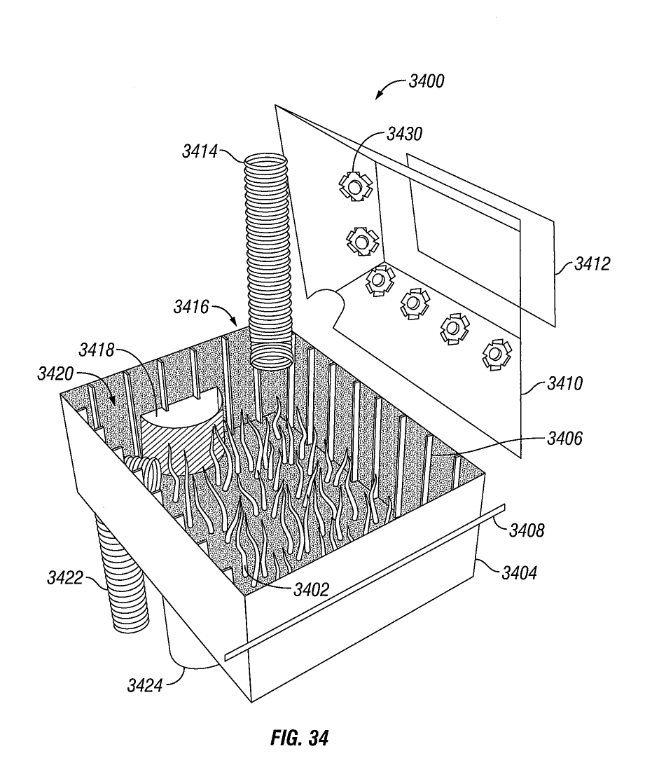

FIG. 34 illustrates a perspective view of an embodiment of an upflow scrubber. In this embodiment, scrubber 3400 utilizes texture appendages 3420, ribbon appendages 3402, and rail appendages 3406. In this embodiment, rail appendages 3406 function similarly to ribbon appendages 3402 because rail appendages 3406 are textured and meant for algal attachment, and also because the upflowing gas bubbles traverse lengthwise along rail appendages 3406. It is to be understood, however, that rail appendages 3406 still allow for one-motion upwards harvesting by reaching into the harvesting door. Ribbon appendages 3402 may extend from a bottom portion of growth compartment 3404. Rail appendages 3406 may extend from sidewalls of growth compartment 3404. Texture appendages 3420 may be formed along an inner surface of any of the sidewalls or bottom portion of growth compartment 3404. Gas bubbles are provided into growth compartment 3404 via an airlift 3422 which directs the bubbles and water to the base of the appendages 3402, 3406, 3420, and also by an overhead water drain conduit 3414 (from an aquarium overflow, etc.) which has an outlet above the internal water level 3408 of growth compartment 3404 and also directs the water and bubbles to the base of the appendages 3402, 3406, 3420. In both cases, the gas bubbles rise up through the turbulent water and rub against ribbon appendages 3402 and rail appendages 3406 during this upwards traversal, finally exploding when they reach the water surface (not shown). Because there is no bubble plate as in the previous upflow growth compartment example, there are no small holes to clog with algal growth, and there is no space for livestock to be trapped. Water and some additional gas bubbles also exit by overflowing into the bubble remover water outlet 3418 which continues downwards to outlet 3424, deep enough to remove substantially all of the gas bubbles; livestock and any loose algae are free to flow out also. The growth compartment 3404 can be coupled to an aquarium wall or sump wall if the aquarium or sump water level will remain relatively constant; alternately, growth compartment 3404 can be floated on the aquarium or sump water surface if floatation means are attached such that a water level 3408 inside growth compartment 3404 does not go above the walls of growth compartment 3404. Embodiments of this example are envisioned also for pools, hot tubs, and ponds. In some embodiments, a top of growth compartment 3404 may form an elevated port 3416, which can be covered by cover 3410 having illumination members 3430 therein. Illumination members 3430 may be LEDs or any other illumination source suitable for algal growth. A top portion 3412 of cover 3410 may be removable to facilitate harvesting of algae from growth compartment 3404. Covers 3410 and 3412 provide a loose fit so as to allow gas to escape. In still further embodiments, an optional bubble remover outlet 3424 may be formed through a bottom portion of growth compartment 3404 to facilitate bubble-free drainage from growth compartment 3404.

While certain embodiments have been described and shown in the accompanying drawings, it is to be understood that such embodiments are merely illustrative of and not restrictive on the broad invention, and that the invention is not limited to the specific constructions and arrangements shown and described, since various other modifications may occur to those of ordinary skill in the art. The description is thus to be regarded as illustrative instead of limiting.

1. A macroalgal attachment apparatus for water filtration or seaweed cultivation, the apparatus comprising:
a set of macroalgal growth appendages, each of the appendages having at least one growth surface; and
a support member, each of the appendages extending from the support member in a discrete and non-connected fashion such that the appendages are capable of receiving water flow and illumination which causes macroalgae to attach to, and grow on, the at least one growth surface, and
wherein the macroalgae can be harvested from the at least one growth surface (1003) to provide useful biomass or to remove nutrients from the water.

2. (canceled)

3. The macroalgal attachment apparatus of claim 1, wherein the appendages are dimensioned such that the macroalgal growth can be comb harvested from the appendages in one continuous motion without the comb becoming entangled in width variations of an appendage.

4. The macroalgal attachment apparatus of claim 1, further comprising:
a gas bubbling means, and wherein the appendages are configured such that a flow of gas bubbles from the gas bubbling means flows in an upward direction along and in contact with the growth surface of at least one of the appendages.

5. The macroalgal attachment apparatus of claim 1, further comprising:
a water delivery means for delivering the water flow, and wherein the appendages are configured to receive the water flow from the water delivery means in a downward direction along the growth surface of at least one of the appendages.

6. The macroalgal attachment apparatus of claim 1, wherein the appendages are configured such that they are oriented in a horizontal or inclined position and receive the water flow in a lengthwise direction along the growth surface of at least one of the appendages.

7. The macroalgal attachment apparatus of claim 1, wherein a distance between the growth surface of each of the appendages is 200 mm or less.

8. (canceled)

9. The macroalgal attachment apparatus of claim 1, wherein a maximum width of each of the appendages is 50 mm or less.

10-12. (canceled)

13. The macroalgal attachment apparatus of claim 1, wherein the appendages are luminous.

14-18. (canceled)

19. The macroalgal attachment apparatus of claim 4, wherein the appendages have a buoy or gas pocket attached to an upper loose end which causes the end to have buoyancy.

20. The macroalgal attachment apparatus of claim 5, wherein the appendages have a weight attached to a lower loose end.

21-38. (canceled)

39. A macroalgal growth compartment for water filtration or seaweed cultivation comprising:
a growth housing having a plurality of walls (2312A, 2312B) which define a compartment capable of being submerged within water and having an internal water depth with substantially all of, the plurality of walls having a textured inner surface; and
a gas bubbling means aligned with the growth housing so that gas bubbles produced by the gas bubbling means are directed to travel along, and in contact with, a textured wall surface, and
wherein macroalgal growth can be harvested from a textured wall surface to provide biomass or to remove nutrients from the water.

40. The macroalgal growth compartment of claim 39, further comprising an illumination means coupled to the growth housing, the illumination means to illuminate the textured inner surface and facilitate macroalgal growth on the surface.

41. The macroalgal growth compartment of claim 39, further comprising a float coupled to the growth housing so as to allow the growth housing to float at a surface of the water which is external to the growth housing.

42. (canceled)

43. The macroalgal growth compartment of claim 39, wherein a textured inner surface includes a submerged top which encloses a portion of the top of the growth housing.

44. The macroalgal growth compartment of claim 39, wherein there are substantially no open ports.

45. The macroalgal growth compartment of claim 39, wherein the textured wall surfaces are formed by rigid protrusions.

46-49. (canceled)

50. An improved macroalgal attachment apparatus for water filtration or seaweed cultivation comprising:
a macroalgal attachment means defining a macroalgal attachment surface; and
a set of water flow guide appendages defining a set of water flow guide surface, wherein each water flow guide appendage is secured to the macroalgal attachment means in an approximately perpendicular fashion such that the cross sectional water flow area is reduced and the set of water flow guide surfaces is aligned with the macroalgal attachment surface such that a is directed to travel along the set of water flow guide surfaces and in contact with the first-macroalgal attachment surface, and
wherein the water flow will travel substantially through algal growth clumps on the macroalgal attachment means as opposed to laterally around the clumps.

51-58. (canceled)

59. The improved macroalgal attachment apparatus of claim 50, wherein the first water flow guide surface is defined by a screen.

60-64. (canceled)

65. The macroalgal growth compartment of claim 39, wherein the internal water depth is less than 60 mm.

66. The macroalgal growth compartment of claim 39, further comprising an illumination port.
